(19) United States
(12) Patent Application Publication
(10) Pub. No.: US 2026/0260175 A1
(43) Pub. Date: Sep. 3, 2026

(54) SYSTEM AND METHOD FOR ITERATIVELY DISTILLING TEACHER MODELS INTO STUDENT MODELS

(71) Applicant: The Toronto-Dominion Bank, Toronto (CA)

(72) Inventors: Satya Krishna GORTI, Toronto (CA); Brendan Leigh ROSS, Toronto (CA); Jiapeng WU, Toronto (CA); Zhaoyan LIU, Toronto (CA); Satya Sai Prasanth YEDURU, Toronto (CA); Noël VOUITSIS, Markham (CA); Guangwei YU, Toronto (CA); Maksims VOLKOVS, Toronto (CA)

(73) Assignee: The Toronto-Dominion Bank, Toronto (CA)

(21) Appl. No.: 19/532,246

(22) Filed: Feb. 6, 2026

Related U.S. Application Data
(60) Provisional application No. 63/765,182, filed on Feb. 28, 2025.

(51) Int. Cl. G06N 20/20

(52) U.S. Cl. CPC G06N 20/20

(57) ABSTRACT

Systems and methods for training a custom embedding models and a custom reranking model based on a foundation embedding model and a foundation reranking model. The systems and methods involve: associating one or more foundation models with a current model designation; and perform an iterative process until a termination condition is satisfied. The iterative process includes: generating, based on the one or more models associated with the current model designation, one or more student models; and associating the generated one or more student models with the current model designation.

The present application claims priority to U.S. provisional application No. 63/765,182, which was filed on Feb. 28, 2025, the contents of which are incorporated herein by reference.

### TECHNICAL FIELD

The present application relates to systems and methods that may be used to improve retrieval systems.

### BACKGROUND

Retrieval systems are difficult to implement, with an example of the difficulty including the trade off between speed and sorting large amounts of data, another example being the difficulty of providing time sensitive outputs in response to determining the sorted document or corpus, etc. One example of a retrieval system is a Retrieval-Augmented Generation (RAG) system, which can be based on an artificial intelligence (AI) technique that combines two steps: retrieving information from a large collection of documents, referred to as a document corpus, and using that information to generate an accurate response. Instead of relying only on what the model was trained on, RAG searches a document database to find relevant details before generating an answer. This helps reduce errors and allows the model to stay updated without needing constant retraining.

However, digitized retrieval systems, such as RAG systems, require large amounts of computing power. Searching large document sets quickly demands more optimized search techniques, while generating responses still relies on heavy AI models that need large amounts of capacity be provided by rare and expensive Graphics Processing Units (GPUs).

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3A is an example schematic diagram of a RAG model;

FIG. 3B is a schematic diagram of a retrieval module of the RAG model of FIG. 3A;

FIG. 4 is a schematic diagram outlining various components of an AI engine;

FIG. 5 shows an end-to-end distillation pipeline for training embedding models and reranking models;

FIG. 6 shows, in flowchart form, a method for training a custom embedding model and a custom reranking model based on a foundation embedding model and a foundation reranking model;

FIG. 7 shows, in flowchart form, an example method for iteratively obtaining custom embedding and custom reranking models until a termination condition is satisfied;

FIG. 8 shows, in flowchart form, a method for determining convergence of performance between custom models and foundation models;

FIG. 9 shows, in flowchart form, a method for determining convergence of performance between current models and previous models;

FIG. 10 shows, in flowchart form, an example method of generating one or more custom models based on synthetic query data;

FIG. 11 shows a schematic diagram of a synthetic query generator;

FIG. 12 shows, in flowchart form, an example method for generating improved synthetic queries;

FIG. 13 shows, in flowchart form, a method for generating synthetic queries for a base document that has newly been added to a document corpus;

FIG. 14 shows, in flowchart form, a method for storing real queries in association with documents in a document corpus;

FIG. 15 shows a schematic diagram of a distilling system;

FIG. 16 shows, in flowchart form, a method for distilling a reranking model by using chain-of-thought data;

FIG. 17A shows a diagram of an architecture of a reranking model obtained by modifying ColBERT by replacing the MaxSim mechanism with a self-attention layer;

FIG. 17B shows a diagram of an architecture of a reranking model obtained by modifying ColBERT by replacing the MaxSim mechanism with a self-attention layer;

FIG. 18 shows, in flowchart form, a method for determining a relevance score based on a query and a document;

FIG. 19 shows, in flowchart form, a method for training a ColBERT model that has been modified by replacing the MaxSim mechanism with a self-attention layer;

FIG. 20 shows an architecture of a reranking model that uses LLM encoders to generate embeddings;

FIG. 21 shows, in flowchart form, a method for determining a relevance score based on a query and a document;

FIG. 22 shows, in flowchart form, a method for comparing the relevance of two documents relative to a query; and

FIG. 23 shows, in flowchart form, a method for modifying an LLM to become or act as an LLM based encoder.

Like reference numerals are used in the drawings to denote like elements and features.

### DETAILED DESCRIPTION OF VARIOUS EMBODIMENTS

In an aspect, the present application relates to a computer system comprising at least one processor and a memory coupled to the at least one processor. The memory stores instructions that, when executed, configure the at least one processor to: associate one or more foundation models with a current model designation; and perform an iterative process until a termination condition is satisfied. The iterative process includes: generating, based on the one or more models associated with the current model designation, one or more student models, the one or more student models being machine learning models; and associating the generated one or more student models with the current model designation. The instructions further configure the at least one processor to deploy the one or more models associated with the current model designation to an artificial intelligence system.

In some implementations, the iterative process further includes: determining that the termination condition is unsatisfied; and triggering, in response to determining that the termination condition is unsatisfied, an iteration of the iterative process.

In some implementations, generating the one or more student models includes distilling knowledge of the one or more models associated with the current model designation to the one or more student models.

In some implementations, the one or more foundation models includes a foundation embedding model and a foundation reranking model.

In some implementations, the termination condition includes at least one criterion, one of the at least one criterion being that, after performing at least one iteration of the iterative process, performance of the one or more student models associated with the current model designation is within a threshold relative to performance of the one or more foundation models.

In some implementations, an iteration of the iterative process further includes, subsequent to associating the generated one or more student models with the current model designation: providing at least one query to the one or more student models associated with the current model designation; receiving, in response to providing the at least one query to the one or more student models associated with the current model designation, at least one reply; determining, based at least on the at least one reply, at least one metric; determining, based on the at least one metric, that a student performance of the one or more student models is within the threshold relative to a foundation performance of the one or more foundation models; and terminating, in response to determining that the student performance of the one or more student models is within the threshold relative to the foundation performance of the one or more foundation models, the iterative process.

In some implementations, an iteration of the iterative process further includes, subsequent to associating the generated one or more student models with the current model designation: providing at least one query to the one or more student models associated with the current model designation; receiving, in response to providing the at least one query to the one or more student models associated with the current model designation, at least one reply; determining, based at least on the at least one reply, at least one metric; determining, based on the at least one metric, that a student performance of the one or more student models is not within the threshold relative to a foundation performance of the one or more foundation models; and triggering, in response to determining that the student performance of the one or more student models is not within the threshold relative to the foundation performance of the one or more foundation models, another iteration of the iterative process.

In some implementations, the termination condition includes at least one criterion, one of the at least one criterion being based on an improvement metric. The iterative process further includes: prior to associating the generated one or more student models with the current model designation, associating the models associated with the current model designation with a previous model designation; and subsequent to associating the generated one or more student models with the current model designation, determining the improvement metric. The improvement metric is determined based on providing at least one query to: the models associated with the previous model designation; and the models associated with the current model designation.

In some implementations, an iteration of the iterative process further includes: determining that the improvement metric indicates that an improvement in performance of the models associated with the current model designation relative to performance of the models associated with the previous model designation is within a threshold; and, in response thereto, terminating the iterative process.

In some implementations, an iteration of the iterative process further includes: determining that the improvement metric indicates that an improvement in performance of the models associated with the current model designation relative to performance of the models associated with the previous model designation is not within a threshold; and, in response thereto, triggering another iteration of the iterative process.

In another aspect, the present application relates to a computer-implemented method for iteratively performing artificial intelligence distillation. The method comprises: associating one or more foundation models with a current model designation; and performing an iterative process until a termination condition is satisfied. The iterative process includes: generating, based on the one or more models associated with the current model designation, one or more student models, the one or more student models being machine learning models; and associating the generated one or more student models with the current model designation. The method further includes deploying the one or more models associated with the current model designation to an artificial intelligence system.

In some implementations, generating the one or more student models includes distilling knowledge of the one or more models associated with the current model designation to the one or more student models.

In some implementations, the one or more foundation models includes a foundation embedding model and a foundation reranking model.

In some implementations, the termination condition includes at least one criterion, one of the at least one criterion being that, after performing at least one iteration of the iterative process, performance of the one or more student models associated with the current model designation is within a threshold relative to performance of the one or more foundation models.

In some implementations, an iteration of the iterative process further includes, subsequent to associating the generated one or more student models with the current model designation: providing at least one query to the one or more student models associated with the current model designation; receiving, in response to providing the at least one query to the one or more student models associated with the current model designation, at least one reply; determining, based at least on the at least one reply, at least one metric; determining, based on the at least one metric, that a student performance of the one or more student models is within the threshold relative to a foundation performance of the one or more foundation models; and terminating, in response to determining that the student performance of the one or more student models is within the threshold relative to the foundation performance of the one or more foundation models, the iterative process.

In some implementations, an iteration of the iterative process further includes, subsequent to associating the generated one or more student models with the current model designation: providing at least one query to the one or more student models associated with the current model designation; receiving, in response to providing the at least one query to the one or more student models associated with the current model designation, at least one reply; determining, based at least on the at least one reply, at least one metric; determining, based on the at least one metric, that a student performance of the one or more student models is not within the threshold relative to a foundation performance of the one or more foundation models; and triggering, in response to determining that the student performance of the one or more student models is not within the threshold relative to the foundation performance of the one or more foundation models, another iteration of the iterative process.

In some implementations, the termination condition includes at least one criterion, one of the at least one criterion being based on an improvement metric. The iterative process further includes: prior to associating the generated one or more student models with the current model designation, associating the models associated with the current model designation with a previous model designation; and subsequent to associating the generated one or more student models with the current model designation, determining the improvement metric. The improvement metric is determined based on providing at least one query to: the models associated with the previous model designation; and the models associated with the current model designation.

In some implementations, an iteration of the iterative process further includes: determining that the improvement metric indicates that an improvement in performance of the models associated with the current model designation relative to performance of the models associated with the previous model designation is within a threshold; and, in response thereto, terminating the iterative process.

In some implementations, an iteration of the iterative process further includes: determining that the improvement metric indicates that an improvement in performance of the models associated with the current model designation relative to performance of the models associated with the previous model designation is not within a threshold; and, in response thereto, triggering another iteration of the iterative process.

In another aspect, the present application relates to a non-transitory computer-readable medium. The computer-readable medium stores computer-readable instructions that, when executed by at least one processor, configure that at least one processor to: associate one or more foundation models with a current model designation; and perform an iterative process until a termination condition is satisfied. The iterative process includes: generating, based on the one or more models associated with the current model designation, one or more student models, the one or more student models being machine learning models; and associating the generated one or more student models with the current model designation. The instructions further configure the at least one processor to deploy the one or more models associated with the current model designation to an artificial intelligence system.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

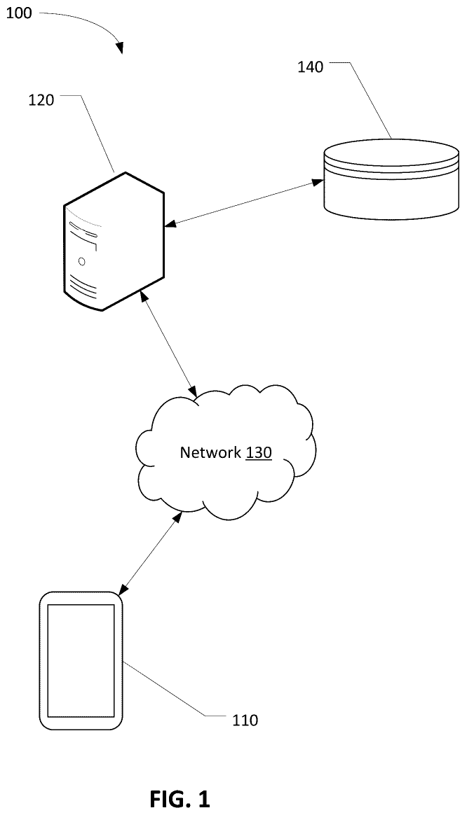

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include or be in communication with a data store 140, such as a memory or other memory store. The memory may store a knowledge base such as a document corpus. The document corpus is a set of documents from which a response to a query may be generated.

The document corpus may include a diverse set of documents. These documents may be structured and/or unstructured. The documents may include publicly available resources and/or private, organization-specific data. Public sources may include Wikipedia articles, news reports, research papers, legal texts, financial reports, and government regulations, which provide general knowledge and domain-specific information. Other types of documents may also be used. Additionally, scientific and technical literature, such as patents, engineering documentation, and API guides may be included in the document corpus.

At least some documents in the document corpus may be private or restricted, accessible only within a specific organization or operating environment. These can include corporate knowledge bases, internal wikis, customer support FAQs, employee handbooks, product manuals, proprietary research reports, etc. In industries like healthcare, law, and finance, confidential documents such as medical records, legal case files, internal compliance reports, and strategic business documents may be integrated while ensuring strict access control. Conversational data, such as chat transcripts, customer service logs, and internal emails, may also be included in private corpora.

In cases where sensitive data is involved in the document corpus, access to the corpus must be carefully managed, with privacy-preserving techniques like differential privacy, encryption, access control mechanisms, and secure APIs.

The document corpus may include documents represented in a text-based format, such as, for example, Microsoft Word™ documents, PDF documents, XML documents, plain text documents. HTML documents, LaTeX™ documents, JSON documents, source code files (e.g., .py, .java, .cpp, cjs, .html, .css, .sh, sql, etc.), Rich Text Format (RTF), e-book documents (.epub, .mobi, .pdf, etc.), email documents (e.g., .eml, .msg, .mbox, etc.), spreadsheet documents, slide decks (e.g., .ppt), and/or documents of another type.

The data store 140 or memory may also store other data, such as a query set. The query set may be a synthetic query set, in at least some implementations. In some implementations, the data store 140 may include real queries, which may be queries extracted from a chatbot or other operator interface which allows for inputting of queries.

The data store 140 may, additionally or alternatively, store training data. The nature of the training data will depend on the nature of the model being trained and the nature of the training data will be understood from the discussion of methods described herein.

The data store 140 may, in some cases, included multiple data stores or elements, some or all of which may be remote from the server computer system 120.

The data store 140 may, additionally or alternatively, store one or more models. The models may be trained computational models that learn patterns from data, such as the training data, to make predictions, generate outputs or perform tasks. The models may be AI models that are built using machine learning, in some implementations.

The server computer system 120 may provide an AI engine by implementing one or more of the models. The server computer system 120 may, in some implementations, operate as or provide a Retrieval-Augmented Generation (RAG) system or RAG model. A RAG system uses a knowledge base, such as the document corpus, to generate responses to queries. The queries may be queries received via a query interface. The query interface may be a user interface that is operated by an operator. The query interface may be output on the computing device 110. The operator may be of any one of a number of types and the nature of the operator will depend on the specific deployment scenario. By way of example, the operators may include customers, website visitors, students, researchers, employees, managers, executives, customer support agents, sales representatives, software developers, engineers, data scientists, AI engineers, it support, system administrators, doctors, medical researchers, lawyers, legal researchers, compliance officers, government officials, law enforcement, investigators, financial analysts, banking professionals, accountants, tax consultants, journalists, writers, marketing specialists, SEO specialists, video creators, podcast creators, online shoppers, retail store employees, supply chain managers, teachers, educators, corporate trainers, chatbots, virtual assistants, automated research tools.

In at least some implementations, the server computer system 120 may integrate the RAG system with a chatbot. The RAG system may enhance the chatbot's ability to provide accurate, contextually relevant responses. When a user submits a query, the chatbot may process and convert the user submitted query into an embedding vector using a pre-trained model. This embedding may then be used to search a vector database containing precomputed document embeddings, retrieving the most relevant documents from a knowledge base that may include FAQs, product manuals, policies, or support articles. The retrieved documents may, in at least some implementations, be ranked/reranked with a reranking model, (also referred to as a reranker). The retrieved documents may then be passed as context to a model, such as a large language model (LLM), which generates a response by combining the retrieved information with the user's query.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

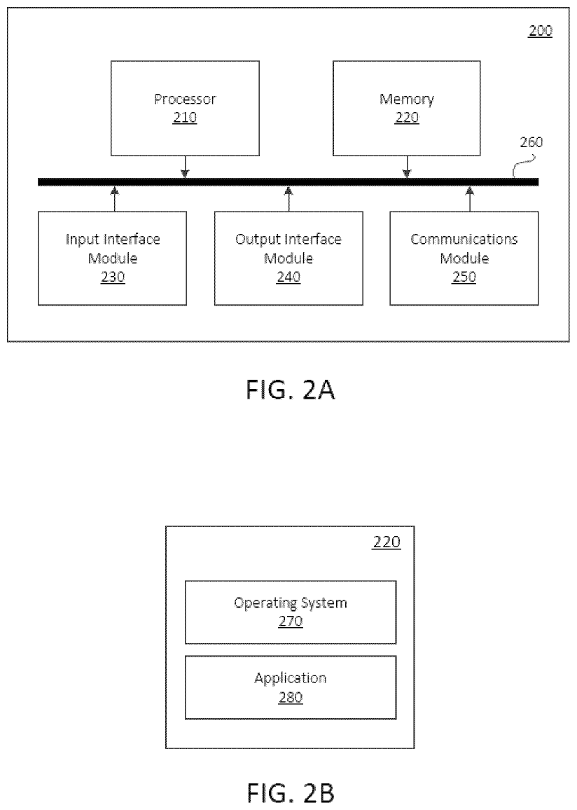

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, GPUs or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated, these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

Rag Models and their Architecture

This application relates to improvements to RAG models. In particular, this application relates to the improvements in the document retrieval capabilities of RAG models. Before discussing these improvements, the RAG models and their architecture will be briefly discussed.

RAG models may be thought of as LLMs that are enhance by inputting documents in addition to queries. LLMs are machine learning models that have been trained to perform natural language processing (NLP). Many people are familiar with LLMs through well-known AI chatbots such as Chat-GPT™ and Google™ Gemini™. In these well-known AI chatbots, textual queries are provided to an LLM which, in turn, generates, based on the textual query, an output or response. LLM-based AI chatbots are very good at NLP and can maintain realistic conversations based on queries and corresponding responses. However, LLMs have been known to, in some instances, hallucinate or provide inaccurate information. RAG models increase the accuracy of the responses of the LLM by augmented the inputted query with a document that is relevant to the query. Specifically, upon receiving an inputted query, a RAG model retrieves one or more documents that are relevant to the query and provides the query and the retrieved documents to an LLM to generate a response. The retrieved documents may be thought of as additional context that is provided to the LLM to improve the quality of the LLM's response.

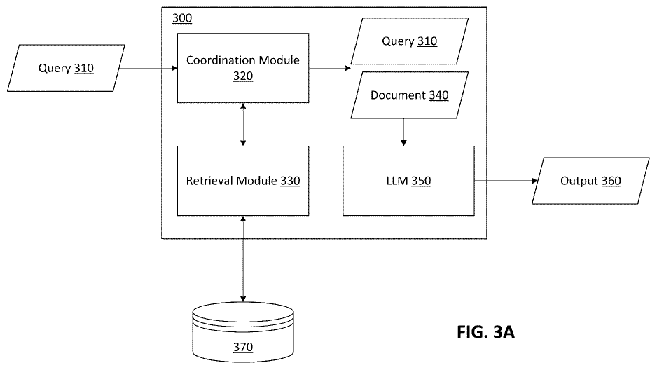

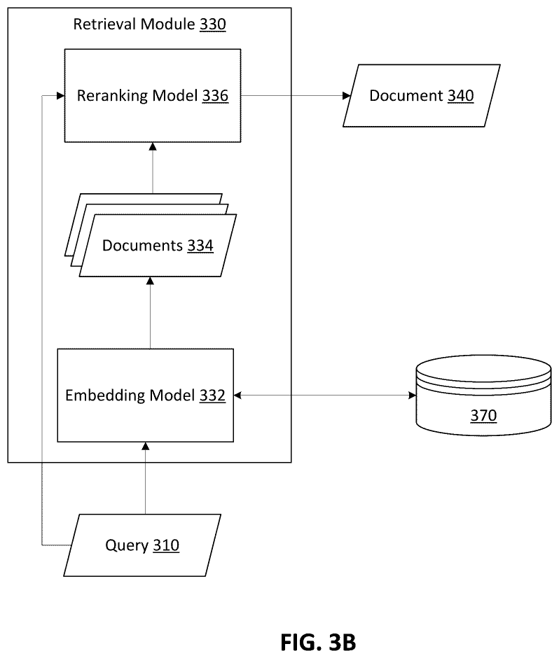

FIG. 3A is an example schematic diagram of a RAG model 300. The RAG model may be provided by or on a server computer such as the server computer system 120. In at least some implementations, the RAG model 300 may be provided on multiple computer systems. These multiple computer systems may operate in a cooperative manner. In at least some implementations, one or more of the models or modules that are illustrated as being provided in the RAG model 300 may, instead, be provided on another system, including a third party system.

FIG. 3A shows the RAG model 300 receiving a query 310. The query 310 may be a textual input to the RAG model 300. The query 310 may be, for example, “What is an electromagnetic wave?” or “Write a poem about swimming pools in a Shakespearean style,” or the query can be a vectorized representation of a user query, etc.

FIG. 3A further shows the RAG model 300 including a coordination module 320. The coordination module 320 is shown receiving the query 310. The coordination module 320 may coordinate the retrieval of documents from a document corpus and the inputting of the query 310 and any retrieved documents to an LLM 350. FIG. 3A shows the coordination module 320 communicating with a retrieval module 330. Specifically, the coordination module 320 may send requests to the retrieval module 330 to retrieve at least one document based on the query 310. The retrieval module 330 may then retrieve, from a database 370, at least one document 340. The retrieval document 340 may retrieve the at least one document 340 based on relevance to the query 310. The at least one document 340 may be one of many documents in a document corpus that is stored in the database 370. After retrieving the at least one document 340, the retrieval module 330 may send the at least one document 340 to the coordination module 320. The coordination module 320 may then provide the query 310 and the at least one document 340 to the LLM 350 to generate an output 360.

The document corpus stored in the database 370 may be a dataset of scientific papers, policy documents of a government department, internal documents of an institution such as a bank, etc. The database 370 may be similar to the data store 140 as described herein with reference to FIG. 1. In the description here, where applicable, the term “database” may be interchangeable with “data store.”

It should be appreciated that while FIG. 3A is described herein with language such as “sending” or “providing” the query 310 and/or the at least one document 340. In some instances, what is being “sent” or “provided” may not be the query 310 and/or the at least one document 340 themselves but representations of the query 310 and/or the at least one document 340. For example, the coordination module 320 or the retrieval module 330 may generate, based on the query 310, embeddings or embedding vectors that represent the query 310. Thus, the retrieval module 330 may retrieve the at least one document 340 from the database 370 based on these embedding vectors. Likewise, what is provided to the LLM 350 may be the embedding vectors as opposed to the actual query 310 itself. Similarly, the retrieval module 330 may retrieve, from the database 370, document embedding vectors that represent the at least one document 340. Hence, what is provided to the LLM 350 may be these document embedding vectors as opposed to the at least one document 340 itself. Hence, while, for simplicity, the description herein uses the terminology “query” and “document” throughout, it should be appreciated that in some instances “query” or “document” may encapsulate the meanings of, without limitation, query data, document data, vector or numerical representations of a query or document, query embeddings, query embedding vectors, document embeddings, and document embedding vectors.

It is also noted that while FIG. 3A shows the LLM 350 as within the RAG system 300, the LLM 350 may be external to the RAG system 300. For example, the LLM 350 can be a web accessed LLM, and the RAG system 300 can query the web-accessed LLM 350 via a, for example, API.

Reference is now made to FIG. 3B which shows a schematic diagram of the retrieval module 330. FIG. 3B shows the retrieval module 330 including an embedding model 332 and a reranking model 336.

The embedding model 332 (also known as an embedder) may be a machine learning model that has been trained to retrieve one or more documents that are relevant to the query 310 from the database 370. In particular, the embedding model 332 may generate, based on the query 310, one or more query embeddings or one or more query embedding vectors that are in an embedding space. The embedding model 332 then obtains one or more documents 334 from the database 370 based on the query embeddings. In particular, the documents of the document corpus stored in the database 370 may have corresponding document embeddings or document embedding vectors in the embedding space. Accordingly, the embedding model 332 may retrieve the one or more documents 334 based on the closeness, relevance, or similarity of their document embeddings to the query embeddings in the embedding space. For example, the one or more documents 334 may be the most relevant k document embeddings to the query embeddings for some number k. In another example, the one or more documents 334 may be the documents of the document corpus that have corresponding document embeddings within a predefined distance or radius from the query embeddings in the embedding space. It should be appreciated that, in some embodiments, closeness or relevance may not merely be a matter of distance in the embedding space. For example, an inner product defined over the embedding space may be used to determine closeness or relevance. For example, documents with document embeddings having a greater inner product with the query embeddings may be considered more relevant or have greater similarity.

In some embodiments, the embeddings, of the query 310 or the documents 334, that the embedding model 332 uses to retrieve the documents 334 may be considered dense embeddings. Dense embeddings may refer to embeddings or embedding vectors that encapsulate an entirety of the object that is embedded. For example, the embedding model 332 may generate a single dense query embedding that represents the query 310 in the embedding space. Likewise, each of the documents 334 may have a single dense document embedding that is the basis for its retrieval by the embedding model 332.

The reranking model 336 (also known as a reranker) may be a machine learning model that has been trained to select, from the one or more documents 334, the document(s) that are most relevant to the query 310 (or the at least one document 340). In some embodiments, the reranking model 336 may be a pointwise reranker wherein the reranking model 336 generates, for each of the one or more documents 334, a relevance score based on that document and the query 310. The reranking model 336 may then select the at least one document 340 based on these relevance scores. That is, the reranking model may select from the one or more documents 334, the documents with the greatest relevance scores. In other embodiments, the reranking model 336 may be a listwise reranker wherein the reranking model 336 simultaneously evaluates the one or more documents 334 to output a list of the one or more documents 334 that is sorted based on relevance to the query 310. Pointwise rerankers differ from listwise rerankers in that pointwise rerankers determine relevance scores for a document independent of other documents. Listwise rerankers, on the other hand, rank documents relative to each other. That is, when determining the relevance of a document, listwise rerankers add the other documents being evaluated to the context.

The reranking model 336 may be implemented using the architecture of a cross-encoder. A cross-encoder is a type of machine learning model that integrates its different inputs. For example, to determine relevance of one of the documents 334 to the query 310, the “dense” approach, as described above with reference to the embedding model 332, would be to generate a query embedding for the query 310, generate a document embedding for the document, and determine the similarity or closeness of these embeddings in an embedding space. In the dense approach, the query 310 and the document are processed independently in that the generation of one embedding does not affect the other. A cross-encoder, on the other hand, would generate an output by processing the query 310 and the document together throughout. For example, the cross-encoder may determine relevance of the query 310 and the document based on embeddings that are generated by processing the query 310 and the document together. That is, these embeddings used by the cross-encoder may encapsulate or represent information relating to both the query 310 and the document. To this end, the cross-encoder may internally generate, by processing the query 310 and the document simultaneously, the embeddings that encapsulate information relating to both the query 310 and the document.

The embedding model 332 may be considered to provide a quick retrieval system with a quick analysis and low computational cost (for example by implementing dense retrieval). Thus, the embedding model 332 is suited for efficiently retrieving, based on the query 310, the one or more documents 334 from the database 370. The reranking model 336 may be considered to provide a less efficient but more fine-grained relevance analysis (for example by using a cross-encoder). Thus, the reranking model 336 is suited for selecting, from the efficiently retrieved one or more documents 334, the most relevant at least one document 340.

As described herein with reference to FIG. 3A, while FIG. 3B is described herein using the term “the query 310,” “the one or more documents 334,” and “the document 340,” in some instances, the term “representations,” “embeddings,” or “embedding vectors,” or the query 310, the one or more documents 334, or the document 340 may be more appropriate. The same may apply to any reference to “query” or “document” herein.

### Distillation of Foundation Embedding Model and Foundation Reranking Model

RAG enhances LLMs by integrating a retrieval system that identifies relevant documents based on user queries. These retrieved documents provide additional context to the model, enabling it to generate more informed and accurate responses. The retrieval process consists of two core stages: embedding retrieval and reranking.

In the embedding stage, a neural network model transforms both the user's query and document chunks into numerical vector representations within a shared embedding space. The most relevant documents are identified by calculating similarity scores—typically using inner product or distance metrics—between the query and document embeddings. This stage is efficient since document vectors can be precomputed, allowing for fast retrieval.

The reranking stage follows, refining the initial set of retrieved documents using a reranker. In this step, a more sophisticated model evaluates the top-k retrieved documents and assigns them improved ranking scores based on their relevance to the query. Unlike embedding-based retrieval, which can be efficiently precomputed, reranking is more computationally expensive as it requires evaluating multiple documents simultaneously. However, it can be a critical step for improving retrieval accuracy, ensuring that the most relevant documents appear at the top of the results list.

One of the key challenges in retrieval pipelines is optimizing performance while maintaining efficiency. Larger models, such as GPT-4 or other advanced LLMs, excel at ranking documents accurately but are expensive to run at scale. To address this, a technique known as distillation is used to transfer knowledge from a larger, more complex model to a smaller, more efficient one. Distillation allows a smaller model to learn from a larger teacher model's behavior, thereby achieving strong performance while significantly reducing computational requirements.

Distillation is a process by which knowledge is transferred from a first, usually large, machine learning model to a second, usually smaller, machine learning model. That is, the first machine learning model may have more parameters, such as weights, than the second machine learning model. In particular, the second model is trained to mimic the behaviour or predictions of the first model. To this end, input data may be provided to the first machine learning model which in turn generates outputs and hidden outputs. The second machine learning model may then be trained based on the input data and its corresponding outputs and hidden outputs. That is, for example, when training the second machine learning model (distilling the first machine learning model, or its knowledge, to the second machine learning model), the loss or the gradient may be computed based on the difference between the hidden outputs and generated outputs of the second machine learning model relative to the hidden outputs and the generated outputs of the first machine learning model given the same input data. The “same” input data may include, for example, the same queries or the same documents from a document corpus. In the context of distillation, the first machine learning model (the model that knowledge is transferred from) may be referred to as a “teacher model” and the second machine learning model (the model that knowledge is transferred to) may be referred to as a “student model.”

The application will now describe herein systems and methods for distilling foundation embedding models and foundation reranking models to more computationally efficient models. Foundation embedding model(s) and foundation reranking model(s) may be embedding model(s) and reranking model(s) that are computationally-intensive and trained on vast amounts of data. In some instances, the needed scope of performance for an embedding model and a reranking model may be limited. For example, the embedding model and the reranking model may only need to facilitate retrieval from a document corpus that is limited in size relative to the vast amount of data that foundation embedding models and foundation reranking models are trained on. Accordingly, for these limited scope uses of embedding models and reranking models, distillation may be employed to obtain custom embedding models and/or custom reranking models that are less computationally-intensive.

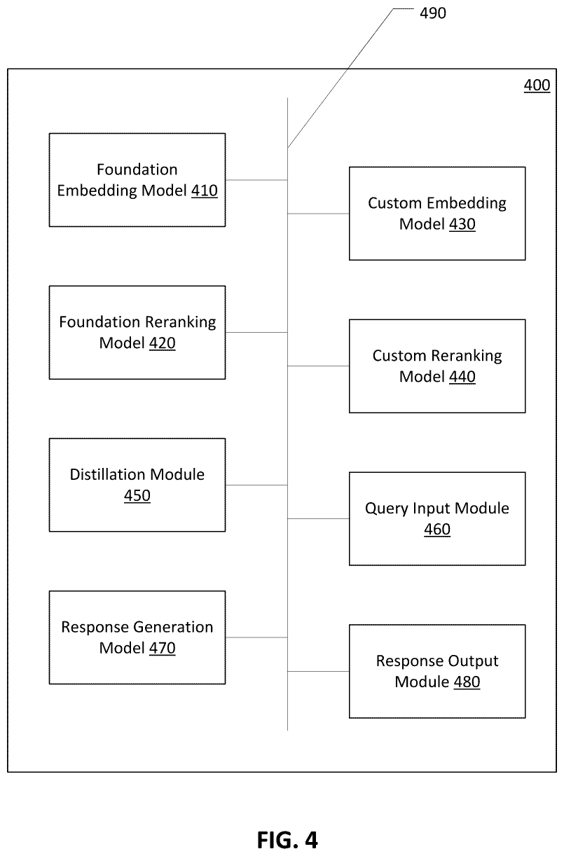

Reference is now made to FIG. 4 which shows an example schematic diagram outlining various components of an engine 400. The engine 400 may be provided by or on the server computer system 120. In at least some implementations, the engine 400 may be provided on multiple computer systems. These multiple systems may operate in a cooperative manner. In at least some implementations, one or more of the models or modules that are illustrated as being provided in the engine 400 may, instead, be provided on another system, including on a third party system.

The engine 400 may also be referred to as an AI system. The engine may, in some implementations, operate as a RAG system and/or a training system.

The engine 400 may include one or more modules and/or models. In the illustrated example, the engine 400 includes embedding models 410, 430, a distillation module 450 and reranking models 430, 440. For example, a foundation embedding model 410 may be included. The foundation embedding model 410 may be a computationally-intensive model which is trained on vast data, apart from a document corpus. In contrast, the custom embedding model 430 may be a less-computationally intensive model that is specifically trained on the document corpus.

Similarly, the foundation ranking model 420 may be trained on data apart from the document corpus while the custom reranking model 440 may be trained on the document corpus, using the foundation ranking model 420 as a teacher model.

A distillation module 450 may distill a knowledge base from a foundation model into a custom model using techniques described herein, for example.

The engine 400 may include a query input module 460. The query input module 460 operates as a front end for receiving queries that may be processed by the engine 400. The query input module 460 may, in some cases, include a chatbot. The query input module 460 may receive queries from a computing device such as the computing device 110.

The engine 400 may pass a query through the custom embedding model 430 in order to identify documents relevant to the query. The engine 400 may then pass such document and the query to a reranking model, such as the custom reranking model 440, in order to better rank the documents based on the query. One or more most relevant documents may then be passed to a response generation model 470, along with the query, to generate a response to the query based on such documents. Then, a response output module 480 may provide the response to the computing device 110. This may involve updating an interface, such as a chat interface, displayed on a display associated with the computing device 110 to output the response.

The various modules and models of the engine 400 may communicate over a bus 490. That is, the various modules and models may send and receive data to each other over the bus 490.

Training of the models, such as the foundation embedding model 410, the foundation reranking model 420, the custom embedding model 430, and the custom reranking model 440, may involve GPU coordination. GPU coordination may include the managing of GPUs and CPUs relating to training the models of the engine 400 for the purposes of optimizing compute resources for training. In some embodiments, such GPUs and/or CPUs may be included in the engine 400.

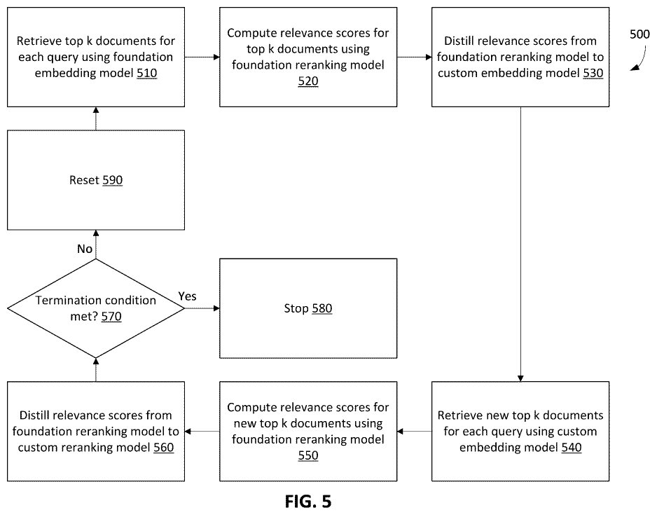

Reference is now made to FIG. 5 which shows an end-to-end distillation pipeline 500. The distillation pipeline 500 may be used to obtain, from a foundation embedding model and a foundation reranking model, a custom embedding model and a custom reranking model. That is, the foundation embedding model and the foundation reranking model may be distilled to the custom embedding model and the custom reranking model. The distillation pipeline 500 may be implemented by a computer system such as the server computer system 120.

The distillation pipeline 500 may be used, in at least some implementations, on a private document corpus. That is, at least some of the documents in the document corpus may be non-public documents such that the distillation allows for desired performance when a model ingests other, similar, documents without exposing the non-public documents.

The document corpus refers to the collection of documents, text files, or knowledge sources that the system searches to retrieve relevant information before generating a response. This document corpus may be a structured collection of documents. This corpus can include a variety of data sources, such as research papers, legal documents, financial records, API documentation, FAQs, or any other structured or unstructured text relevant to the application.

By way of example, the document corpus might include transaction policies, fraud detection guidelines, tax codes, or customer support knowledge bases, allowing the AI to retrieve precise information before generating its final answer. The types of documents in the document corpus will vary depending on the application.

As set up to the distillation pipeline 500, there may be a plurality of queries and the document corpus. The plurality of queries may be textual queries that are answerable by the document corpus. For example, if the document corpus is a collection of scientific research papers, the plurality of queries may be science questions that can be answered by the scientific research papers. In another example, the document corpus includes architectural and technical materials related to computing systems and/or related programming, and the queries may be attempts to debug or troubleshoot systems. In another example, if the document corpus is a collection of policy documents of a financial institution, the plurality of queries may be questions related to services of the financial institution. The document corpus may include at least some private (i.e., non-public) documents. The plurality of queries may be stored in a database or a memory, such as, for example, memory associated with the system executing the distillation pipeline 500. In at least some instances, the queries may be stored in an embedded format using vector representations, embeddings, or embedding vectors.

The document corpus may store documents in an embedded format using vector representations. Each document (or document chunk or other text snippet) may be converted to a dense vector embedding using a pre-trained embedding model and may be stored in a vector database. The vector database may be optimized for rapid similarity searches. The documents may also be stored in a non-embedded format, such as by storing the raw text and/or full text of each document.

The distillation pipeline 500 includes a step 510. The step 510 includes using the foundation embedding model to retrieve, for each of the plurality of queries, the top k documents for some number k. That is, each query is provided to the foundation embedding model which in turn retrieves, from the document corpus, the k most relevant queries to the given query.

The foundation embedding model may be a large-scale pre-trained model that generates vector representations of data, such as text, in a continuous space. This model may have been trained on extensive datasets to learn generalizable features that can be applied across various tasks, such as information retrieval, classification, and clustering. The model may map input data to a high-dimensional numerical space, or embedding space, where semantically similar items are positioned closer together, enabling efficient similarity comparisons.

The foundation embedding model may compare the embedding of a query with stored document embeddings. This comparison may use a cosine similarity, for example. In some instances, the comparison may use a dot product or inner product.

The foundation embedding model selects a particular number of documents, which are determined to be most relevant to the query. That is, the foundation embedding model selects the documents having the highest similarity scores.

By way of example, if the initial query is “How do I reverse a global wire transfer?” and the foundation embedding model is configured to identify three documents, an example ranking may be as follows:

| | Cosine Similarity |
|---|---|
| | Score (Foundation |
| Document ID | Embedding Model) |
| D1: “Can You Reverse an International Wire | 0.83 |
| Transfer?” | |
| D2: “Steps to Cancel a Wire Transfer: | 0.80 |
| Domestic and Global” | |
| D3: “Understanding Wire Transfer Reversals | 0.78 |
| and Refunds” | |

Following the step 510, the distillation pipeline 500 proceeds to a step 520. The step 520 includes using the foundation reranking model to compute, for each query and its most relevant k documents (as retrieved by the foundation embedding model), relevance scores.

The documents that are identified at the step 510 may be reranked at the step 520. The foundation reranking model may be RankGPT. In other implementations, other reranking models may be used. The foundation reranking model may assign a relevance score based on a query document match.

The foundation reranking model may process the actual text content of the documents retrieved at the step 510. The foundation reranking model may analyze how well each retrieved document's meaning aligns with the query. The foundation reranking model then reranks the retrieved documents based on this deeper contextual understanding. This reranking may include assigning a new relevance score to each document. For example, relevance scores may be assigned based on the query-document match.

The foundation reranking model is generally more computer-intensive than the foundation embedding model but it provides a more accurate ranking. In this way, the foundation embedding model effectively operates as a coarse filter to reduce the number of documents that are to be evaluated by the computationally-intensive foundation ranking model.

Using the example provided above regarding the initial query of “How do I reverse a global wire transfer?”, an example reranking performance may be as follows.

| Document ID | New Score (Reranker) | New Rank |
|---|---|---|
| D2: “Steps to Cancel a Wire | 0.92 | 1 |
| Transfer: Domestic and Global” | | |
| D1: “Can You Reverse an | 0.90 | 2 |
| International Wire Transfer?” | | |
| D3: “Understanding Wire | 0.87 | 3 |
| Transfer Reversals and Refunds” | | |

Following the step 520, the distillation pipeline 500 may proceed to a step 530. The step 530 includes distilling relevance scores from the foundation reranking model to a custom embedding model. The distillation process of the relevance scores to the custom embedding model may involve training the custom embedding model based on the difference between outputs (including hidden outputs) of the custom embedding model given the plurality of queries and the expected outputs (including hidden outputs) generated by the foundation reranking model. Put another way, the foundation reranking model's knowledge may be distilled into the custom embedding model. For example, a new embedding model may be trained on the relevance scores or rankings provided by the foundation reranking model. This new embedding model, which may be referred to as a custom embedding model, may have a lower computational overhead than the foundation embedding model.

Since the custom embedding model can be trained, in part, based on a private document corpus, which may be the same document corpus that the custom embedding model uses for RAG after training, it may be highly accurate even though it has less computational overhead than the foundation embedding model. By training a new embedding model on the relevance scores produced by the foundation reranking model, the retrieval process improves, allowing future queries to return better-ranked documents directly from the embedding stage. This may enhance the efficiency of the retrieval operation when operating a RAG model since embedding retrieval is significantly faster than reranking, so a more powerful embedding model reduces the dependency on costly reranking computations.

During the step 530, the custom embedding model may be stored in a storage medium such as a database.

Following the step 530, the distillation pipeline 500 may proceed to a step 540. The step 540 may include using the custom embedding model (trained in the step 530) to retrieve, for each of the plurality of queries, a new top k documents. That is, each query is provided to the custom embedding model which in turn retrieves, from the document corpus, the new k most relevant queries to the given query.

The step 540 may be similar to the step 510, except that it is performed using the custom embedding model rather than the foundation embedding model. The retrieval may be performed on the same document corpus that was used in the step 510.

Following the step 540, the distillation pipeline 500 may proceed to a step 550. The step 550 may include using the foundation reranking model to compute for each query and its new most relevant k documents (as retrieved by the custom embedding model) relevance scores.

Following the step 550, the distillation pipeline 500 may proceed to a step 560. The step 560 includes distilling relevance scores from the foundation reranking model to a custom reranking model. The distillation process of the relevance scores to the custom reranking model may involve training the custom reranking model based on the difference between outputs (including hidden outputs) of the custom reranking model given the plurality of queries and the expected outputs (including hidden outputs) generated by the foundation reranking model. Put another way, the custom reranking model may be trained, learning from the ranking decisions made by the foundation reranking model. The conclusion of the step 560 may result in a custom reranking model that mimics the foundation embedding model and/or the foundation reranking model with respect to the plurality of queries and the relevance scores computed in the step 550.

During the step 560, the custom reranking model may be stored in a storage medium such as a database.

Following the step 560, if a termination condition is met at a step 570, the distillation pipeline 500 stops at a step 580. Otherwise, the distillation pipeline 500 may reset at a step 590. If the distillation pipeline 500 resets at the step 590, the distillation pipeline 500 proceeds to the step 510. In this scenario, the foundation embedding model is replaced by the custom embedding model obtained in the step 530 and the foundation reranking model is replaced by the custom reranking model obtained in the step 560. Thus, it may be said that the distillation pipeline 500 is a loop wherein, in an iteration of the loop, knowledge is transferred from teacher embedding and reranking models to student embedding and reranking models and the student embedding and reranking models become the teacher embedding and reranking models of the next iteration. In the iteration of the distillation pipeline 500, the teacher embedding and reranking models of the first iteration are the foundation embedding and reranking models. When the loops end at the step 580, the final student embedding and reranking models may be deployed to be used in a RAG model.

The termination condition may include one or more criteria. The one or more criteria may include that performance of the custom (student) embedding and reranking models, at the step 570, have sufficiently converged to the performance (or foundation performance) of the foundation embedding and reranking models. Additionally or alternatively, the one or more criteria may include that improvement of the student embedding and reranking models relative to the teacher embedding and reranking models has neared 0. This improvement may be measured, according to, without limitation, computational overhead costs.

In this way, both a custom reranking model and a custom embedding model may be obtained. These models may then be deployed in an operating environment to respond to new queries. For example, these models may be deployed, after the step 580, in an operating environment to respond to new queries that may not be in the plurality of queries that was used in the distillation pipeline 500. That is, these models may be used in place of a foundation model. In some instances, the models may be deployed in a RAG system which is used with a chatbot. For example, queries may be issued via chat and answers may be generated based on the document set using the custom embedding and reranking models.

The distillation pipeline 500 provides for bidirectional distillation between the embedding model and the reranking model. Typically, embedding models and reranking models are trained separately, with the embedding model focused on retrieving broadly relevant documents and the reranking model refining the ranking. However, the distillation pipeline 500 takes a different approach by directly training the embedding model using the output of the reranking model. This integration may enhance the embedding model's effectiveness, allowing it to retrieve documents in a way that already aligns more closely with the reranking model's judgment. As a result, the system may gradually reduce its reliance on computationally expensive reranking while improving retrieval accuracy.

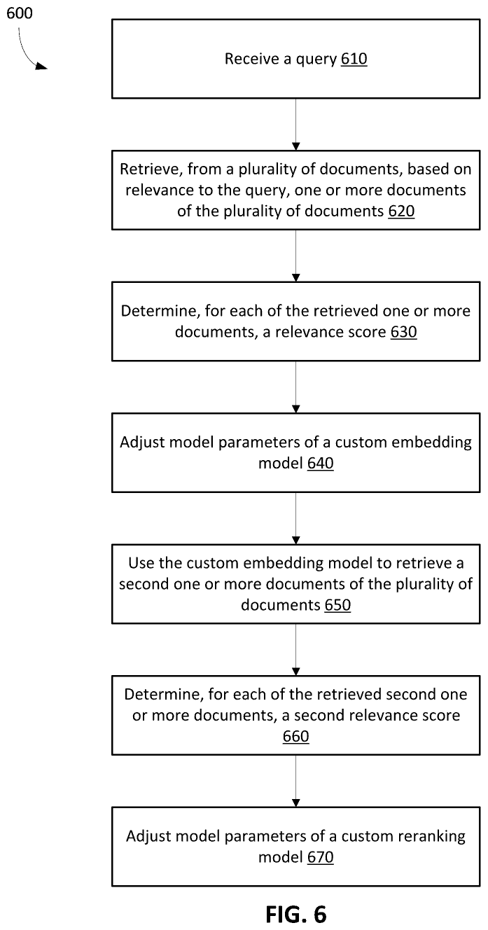

Reference is now made to FIG. 6 which illustrates an example method 600 for generating a custom embedding model and a custom reranking model. The method may be used to reduce an amount of computer power required in a RAG system. For example, the method 600 may be used to generate more computationally efficient models. The method 600 may be considered an implementation of at least part of an iteration of the distillation pipeline 500 as described herein with reference to FIG. 5.

The method 600 may, in least some implementations, be performed by one or both of a processor and a computer. For example, a memory may store instructions which, when executed, configure one or both of the processor and the computer to perform the method 600 or a portion thereof. “A processor” or “a computer” as used herein may include multiple processors or computers as the case may be. Similarly, “a memory” as used herein may include multiple memories.

The method 600 may, in at least some implementations, be configured to create optimized embedding and reranking models that work effectively on a private document corpus. In at least some implementations, the method 600 may be used to develop an efficient, high-performing retrieval system that can operate at scale while maintaining accuracy.

The method 600 may use a foundation embedding model and a foundation reranking model. These foundation models may be publicly available models. The foundation models may be fine-tuned for retrieval tasks. For reranking, the method may, for example, use RankGPT as a foundation model. Other rankers may also be used.

Prior to performing the method 600, a set of example queries may be stored in memory such as, for example, memory associated with the system performing the method 600.

The method 600 may begin with an operation 610. The operation 610 may include receiving a query. The query may be a textual query such as the query 310 as described herein with reference to FIGS. 3A and 3B.

Following the operation 610, the method 600 may proceed to an operation 620. The operation 620 may include retrieving, from a plurality of documents, based on relevance to the query, one or more documents of the plurality of documents. The plurality of documents may be a document corpus such as those described herein with reference to FIGS. 3A-5. The retrieving of the one or more documents may include providing the query to a foundation embedding model. The foundation embedding model may, in turn, retrieve from the plurality of documents, the one or more documents.

Following the operation 620, the method 600 may proceed to an operation 630. The operation 630 may include determining, for each of the retrieved one or more documents, a relevance score. The determining of the relevance score may include comparing the respective one of the one or more documents to the query. Computing the relevance score of at least one of the one or more documents may include providing the query and the at least one of the one or more documents to a foundation reranking model. The foundation reranking model may then compare the query to the at least one of the one or more documents to compute the relevance score of the at least one of the one or more documents. The foundation reranking model may be, without limitation, a pointwise reranker or a listwise reranker.

Following the operation 630, the method 600 may proceed to an operation 640. The operation 640 may include adjusting, based on the determined one or more relevance scores, model parameters of a custom embedding model. The custom embedding model may be a model that is “smaller” than the foundation embedding model. That is, the custom embedding model may have less parameters than the foundation embedding model.

The operation 640 may be executed as part of a distillation process. The distillation process may include the transfer of knowledge from at least one of the foundation embedding model and the foundation reranking model to the custom embedding model.

Following the operation 640, the method 600 may proceed to an operation 650. The operation 650 may include using the custom embedding model to retrieve a second one or more documents of the plurality of documents.

Following the operation 650, the method 600 may proceed to an operation 660. The operation 660 may include determining, for each of the retrieved second one or more documents, a second relevance score. The determining of the second relevance score may include comparing the respective one of the second one or more documents to the query. Determining the second relevance score of at least one of the second one or more documents may include providing the query and the at least one of the second one or more documents to the foundation reranking model. The foundation reranking model may then compare the query to the at least one of the second one or more documents to compute the relevance score.

Following the operation 660, the method 600 may proceed to an operation 670. The operation 670 may include adjusting, based on the determined second one or more relevance scores, model parameters of a custom reranking model.

The operation 660 may be executed as part of a distillation process. The distillation process may involve the transfer of knowledge from at least the foundation reranking model to the custom reranking model.

It should be appreciated that the method 600 may be considered an implementation of the steps 510 to 560 of the distillation pipeline 500, as described herein with reference to FIG. 5, wherein the method 600 follows the processing in relation to a single query. Generalizing the method 600 to apply to multiple or many queries would yield operations similar to those involved in the steps 510 to 560.

Following execution of the method 600, the custom embedding model and the custom reranking model may be deployed to be used in a RAG model such as the RAG model 300 as described herein with reference to FIG. 3A. In an example scenario, the RAG model may be used to implement an AI chatbot. Thus, the custom embedding model may function similarly to the embedding model 332 as described herein with reference to FIG. 3B and the custom reranking model may function similarly to the reranking model 336 as described herein with reference to FIG. 3B. For example, the custom embedding model may receive a generated query that is generated by a user of the RAG model. The custom embedding model may then retrieve, from the plurality of documents, another one or more documents. The generated query and the another one or more documents may then be provided to the custom reranking model. The custom reranking model may then determine, for each of the another one or more documents, another relevance score. The determining of the another relevance score may include comparing the respective one of the another one or more documents to the generated query.

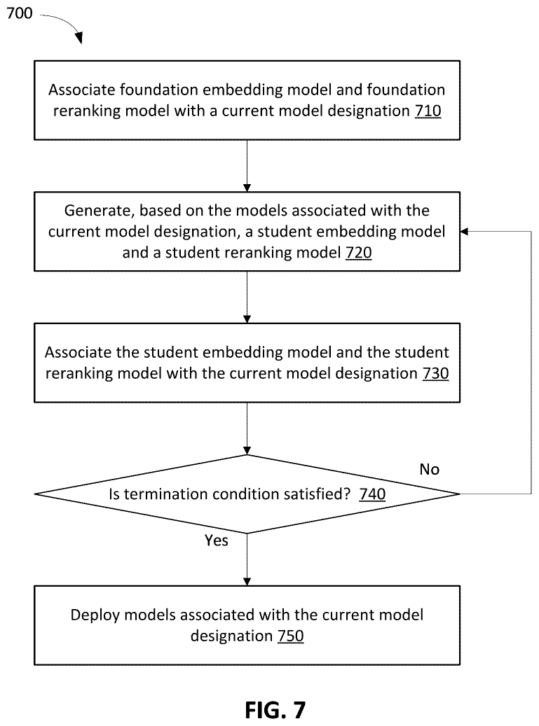

As described herein with reference to FIG. 5, distilling the knowledge of a foundational embedding model and a foundation reranking model to a custom embedding model and a custom reranking model may be done iteratively. Reference is now made to FIG. 7 which shows an example method 700 for iteratively obtaining student (custom) embedding and student (custom) reranking models until a termination condition is satisfied. The method 700 may be considered to implement at least part of the distillation pipeline 500 as described herein with reference to FIG. 5.

The method 700 may, in at least some implementations, be performed by one or both of a processor and a computer. For example, a memory may store instructions which, when executed, configure one or both of the processor and the computer to perform the method 700 or a portion thereof. “A processor” or “a computer” as used herein may include multiple processors or computers as the case may be. Similarly, “a memory” as used herein may include multiple memories.

The method 700 may include any features described above with reference to the distillation pipeline 500 of FIG. 5 or the method 600 of FIG. 6. For example, the method 700 may include the operations 610 to 670 of the method 600.

The method 700 may begin with an operation 710. The operation 710 may include associating a foundation embedding model and a foundation reranking model with a current model designation. The current model designation may be thought of as a way to keep track of the most recent version of an embedding model and a reranking model as the distillation pipeline 500 continues to iterate. In practice, a computer system associated with the distillation pipeline 500 may not actively make an association between the foundation models and the current model designation. For example, in implementing this association in computer code, associating the foundation models with the current model designation may be a matter of having pointer variables point to the foundation models. Models designated with the current model designation may be referred to as “current” models.

Following the operation 710, the method 700 may proceed to an operation 720. The operation 720 may include generating, based on the models associated with the current model designation, a student embedding model and a student reranking model. The generating of the student embedding model and the student reranking model may be similar to the steps 510 to 560 of the distillation pipeline 500 as described herein with reference to FIG. 5 or the operations 610 to 670 of the method 600 as described herein with reference to FIG. 6.

Following the operation 720, the method 700 may proceed to an operation 730. The operation 730 may include associating the student embedding model and the student reranking model with the current model designation. Associating the student embedding model and the student reranking model with the current model designation indicates that the student embedding model and the student reranking model are the most recent versions of custom embedding models and custom reranking models. In practice, associating the student models with the current model designation may be a matter of, for example, having pointer variables point to the student models. Additionally or alternatively, the student models may be associated with version numbers which indicate that the student models are the most recent models. Additionally or alternatively, the student models may be associated with a timestamp of their generation which, in turn, indicates that they are the most recent models.

Following the operation 730, the method 700 may proceed to a decision 740. The decision 740 includes determining whether a termination condition is satisfied. The termination condition may include one or more criteria. The criteria may include that, after performing at least one iteration of the method 700 (performing the operations 720 and 730 at least once), performance of the current models are within a threshold relative to performance of the foundation models. The criteria may include, for example, convergence of performance of the “current” models relative to the foundation models. Additionally or alternatively, the criteria may include that performance of the “current” models has not, or minimally, improved relative to previous versions of the embedding model and the reranking model.

If the termination condition is not satisfied at the decision 740, the method 700 may return to the operation 720. This would result in the generating of new student models based on the models associated with the current model designation (which were the student models the last time at the operation 720). In this way, the method 700 is iterative. It may be said that the method 700 includes performing an iterative process until the termination condition is satisfied, the iterative process including the operation 720 and the operation 730. Further, it may be said that failing to satisfy the termination condition at the decision 740 results in a triggering of another iteration of the iterative process.

If the termination condition is satisfied, the method 700 may proceed to an operation 750. The operation 750 may include deploying the models associated with the current model designation (the most recently generated models) to be used in a RAG model such as the RAG model 300 as described herein with reference to FIG. 3A.

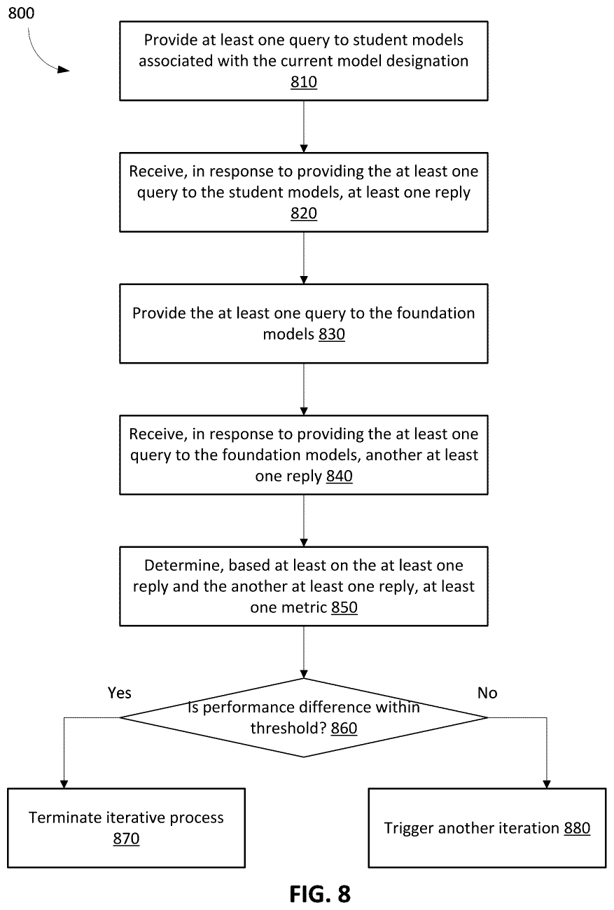

In some embodiments, the one or more criteria of the termination condition include that performance of the current models have sufficiently converged to the performance of the foundation models. Reference is now made to FIG. 8 which shows, in flowchart form, a method 800 for determining convergence of performance between the “current” models and the foundation models.

The method 800 may, in least some implementations, be performed by one or both of a processor and a computer. For example, a memory may store instructions which, when executed, configure one or both of the processor and the computer to perform the method 800 or a portion thereof. “A processor” or “a computer” as used herein may include multiple processors or computers as the case may be. Similarly, “a memory” as used herein may include multiple memories.

The method 800 may be performed as an implementation of the decision 740 of the method 700.

The method 800 may begin with an operation 810. The operation 810 may include providing at least one query to the current models. Following the operation 810, the method 800 may proceed to an operation 820. The operation 820 may include receiving, in response to providing the at least one query to the current models, at least one reply. Following the operation 820, the method may proceed to an operation 830. The operation 830 may include providing the at least one query to the foundation models. Following the operation 830, the method 800 may proceed to an operation 840. The operation 840 may include receiving, in response to providing the at least one query to the foundation models, another at least one reply.

The at least one query may be a query that has been set aside or stored for the purpose of testing the performance of the current models against the foundation models.

In some embodiments, the at least one reply and the another at least one reply may be obtained via passing the output of the embedding models to the reranking models. That is, for example, the at least one query may be provided to the current embedding model which, in turn, outputs, for each of the at least one query, one or more documents from a document corpus. These one or more documents from the document corpus may then be passed, along with the at least one query, to the current reranking model to select at least one document from the one or more documents. These at least one documents may be considered to be, or be included in, the at least one reply. Likewise, the at least one query may be provided to the foundation embedding model which, in turn, outputs, for each of the at least one query, another one or more documents form the document corpus. These another one or more documents may be passed, along with the at least one query, to the foundation reranking model to select another at least one document from the another one or more documents. These another at least one documents may be considered to be, or be included in, the at least one reply. In these embodiments, convergence of performance between the current models and the foundation models may be measured and/or analyzed as a whole. That is, the result of the current models working together to retrieve documents is compared to the result of the foundation models working together to retrieve documents.

In other embodiments, the at least one reply and the another at least one reply may include outputs that are obtained from the embedding models and reranking models independent of each other. For example, the at least one query may include an embedding testing query that is provided to the current embedding model and the foundation embedding model. The current embedding model and the foundation embedding model may then respectively retrieve, from the document corpus, one or more documents based on the embedding testing query. Likewise, the at least one query may include a test set of documents and a reranking testing query that is provided to the current reranking model and the foundation reranking model. The current reranking model and the foundation reranking model may then respectively rank the documents in the set based on the reranking testing query. The outputs of the current models may be considered to be included in the at least one reply and the outputs of the foundation models may be considered to be included in the another at least one reply. In these embodiments, performance of the current embedding model may be directly compared against performance of the foundation embedding model. Likewise, performance of the current reranking model may be directly compared against performance of the foundation reranking model.

Following the operation 840, the method 800 may proceed to an operation 850. The operation 850 may include determining, based at least on the at least one reply, at least one metric. The metric may be one of “closeness” between the at least one reply and the another at least one reply. For example, retrieved or selected documents may have corresponding vector representations in an embedding space. Accordingly, the metric may be based on distances between these representations in an embedding space. Additionally or alternatively, an inner product over the embedding space may be used to determine the metric. That is, the metric may be based on inner products between the at least one reply and the another at least one reply in the embedding space. Determining the at least one metric may include using any number of mathematical operations including summation and multiplication. For example, if the at least one metric is based on “closeness” within the embedding space, the at least one metric may include an average of the distances between the at least one reply and the another at least one reply. In another example, if the metric is based on an inner product, the metric may include an average of the inner products of the embeddings of the at least one reply and the embeddings of the another at least one reply.

Following the operation 850, the method 800 may proceed to a decision 860. The decision 860 may include determining if the performance difference between the current models and the foundation models are within a threshold. That is, the decision 860 includes determining, based on the at least one metric, whether the performance of the current models is within the threshold relative to the performance of the one or more foundation models. The threshold may be, for example, a predefined real number. If performance of the current models is not within the threshold relative to the performance of the one or more foundation models, according to the at least one metric, the method 800 may proceed to an operation 880 wherein another iteration of the iterative process in the method 700 is triggered. That is, performing the operation 880 results in performing the operation 720 of the method 700. On the other hand, if it is determined, at the decision 860, that performance of the current models are within the threshold relative to performance of the foundation models, the method 800 may proceed to an operation 870. The operation 870 may include terminating the iterative process of the method 700.

It should be appreciated that in some embodiments or scenarios, the operations 830 and 840 may be skipped. For example, if the same queries are going to be used to test performance of the current models against the foundation models, the another at least one reply may be predetermined and stored in a database. The predetermined another at least one reply may be retrieved from the database for the purposes of comparing performance of the current models to the foundation models.

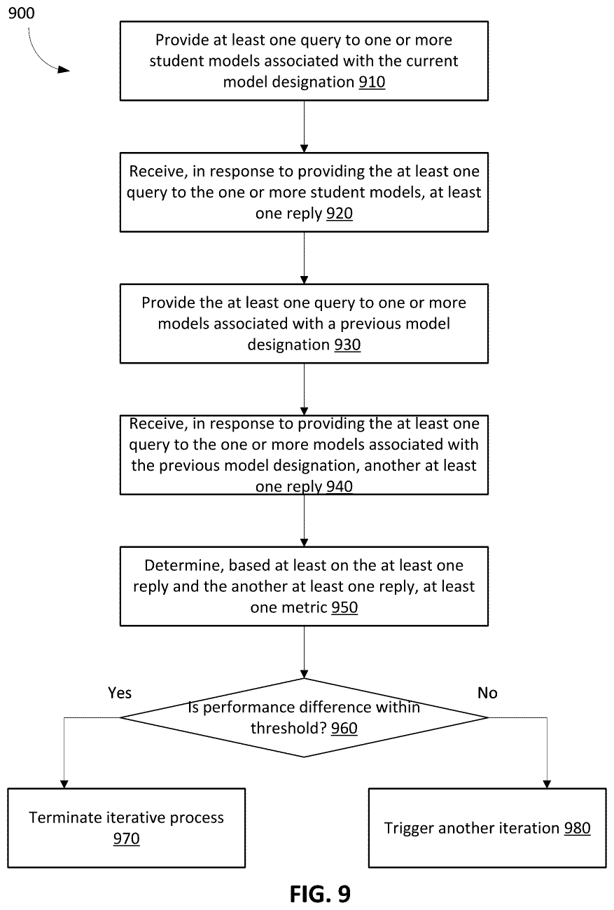

Reference is now made to FIG. 9 which shows, in flowchart form, a method 900 for determining convergence of performance between the current models and the “previous” models. This may be thought of as determining a lack of improvement in an additional iteration of the iterative process of the method 700.

The method 900 may, in least some implementations, be performed by one or both of a processor and a computer. For example, a memory may store instructions which, when executed, configure one or both of the processor and the computer to perform the method 800 or a portion thereof. “A processor” or “a computer” as used herein may include multiple processors or computers as the case may be. Similarly, “a memory” as used herein may include multiple memories.

The method 900 may be performed as an implementation of the decision 740 of the method 700. In particular, the method 900 may implement the decision 740 when the termination condition includes a criterion that is based on an improvement metric.

The method 900 may begin with an operation 910. The operation 910 may include providing at least one query to the current models. Following the operation 910, the method 900 may proceed to an operation 920. The operation 920 may include receiving, in response to providing the at least one query to the current models, at least one reply.

Following the operation 920, the method 900 may proceed to an operation 930. The operation 930 may include providing the at least one query to one or more models associated with a previous model designation. The previous model designation may be considered a tracker that tracks the previous versions of the custom models obtained via the iterative processes of the distillation pipeline 500 or the method 700. For example, the method 700 may include, prior to associating the generated one or more student models with the current model designation, associating the models associated with the current model designation with a previous model designation. Models associated with the previous model designation may be referred to as “previous models.” In the context of distillation, the previous models may simply be the teacher models.

Following the operation 930, the method 900 may proceed to an operation 940. The operation 940 may include receiving, in response to providing the at least one query to the previous models, another at least one reply.

Following the operation 940, the method 900 may proceed to an operation 950. The operation 950 may include determining, based at least on the at least one reply and the another at least one reply, at least one metric. The at least one metric may be considered an improvement metric because it compares performance of the current models relative to the previous models. The at least one metric may otherwise be similar to the at least one metric of the method 800 as described herein with reference to FIG. 8. Additionally or alternatively, the at least one metric may be a runtime-based or speed-based metric wherein runtime is used as an indication of computational overhead. Additionally or alternatively, faster models may be considered better. For example, the operation 920 may include using a timer to measure time from when the at least one query was provided to the current models to when the current models output the at least one reply. Likewise, the operation 940 may include using the time to measure time from when the at least one query was provided to the previous models to when the previous models output the another at least one reply. The metric may be based on the difference between these times.

Following the operation 950, the method 900 may proceed to a decision 960. The decision 960 includes determining whether the at least one metric indicates that the improvement in performance of the current models relative to the performance of the previous models is within a threshold (and thereby indicate that improvement has plateaued). If the improvement has plateaued, the method 900 may proceed to an operation 970 wherein the iterative process is terminated. Otherwise, the method 900 may proceed to an operation 980 wherein another iteration of the iterative process is triggered. That is, the operation 980 may cause another performance of the operation 720 of the method 700.

The iterative distillation process, as described herein with reference to FIGS. 5-9 may offer several advantages. First, it may improve retrieval efficiency by optimizing the embedding model through feedback from the reranking model using the techniques described above with reference to FIGS. 5-9. Traditionally, retrieval pipelines rely heavily on reranking models to refine results, but this approach may shift much of that responsibility to the embedding stage, reducing computation costs while maintaining high accuracy.

Second, it may ensure that the retrieval system is continuously optimized for a private document corpus. Unlike generic retrieval models trained on large public datasets, this method may tailor the retrieval pipeline to the specific needs of the given data domain. The ability to finetune both the embedding and reranking models in an iterative manner makes this approach particularly effective for specialized applications where domain-specific relevance is critical.

Third, this approach enables scalability. By distilling knowledge from larger models into progressively smaller and more efficient models, organizations can deploy high-performing retrieval systems without requiring expensive computational resources. This is particularly valuable for real-time applications where fast response times are needed.

Additionally, the bidirectional distillation between the reranking model and the embedding model may enhance the overall quality of retrieval. Instead of treating embedding and reranking as separate components, a feedback loop is created where each model improves based on the other's outputs. This may make the embedding model far more effective at retrieving relevant documents, ultimately improving the user experience.

Training with Synthetic Query

The distillation pipeline 500, as described herein with reference to FIG. 5, trains the custom embedding model and the custom reranking model based on queries. However, in some circumstances, there may be an insufficient amount of ready-to-use queries that can be used to train the custom embedding model and the custom reranking model. In such situations, synthetic queries may be generated to train the custom embedding model and the custom reranking model.

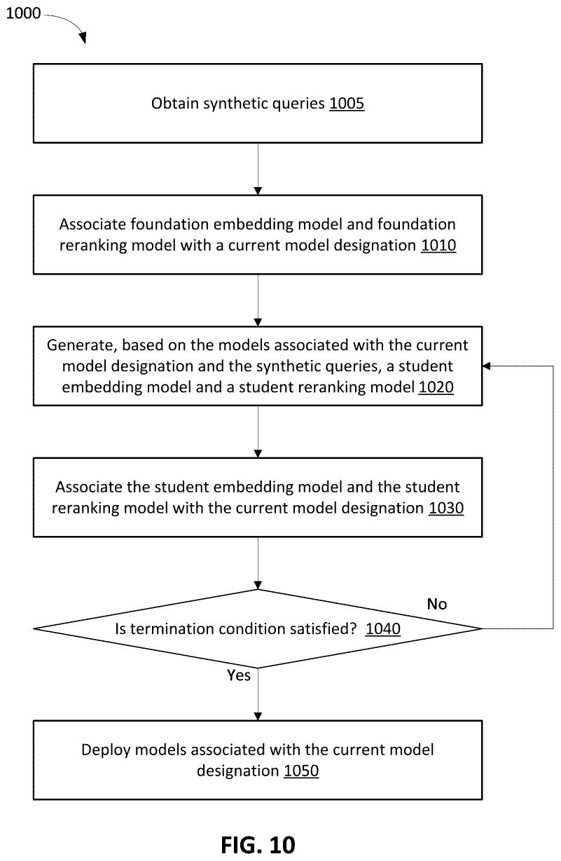

Reference is now made to FIG. 10 which illustrates an example method 1000 of generating one or more custom models based on synthetic query data. The method 1000 may, in least some implementations, be performed by one or both of a processor and a computer. For example, a memory may store instructions which, when executed, configure one or both of the processor and the computer to perform the method 1000 or a portion thereof.

The method 1000 may include an operation 1005. The operation 1005 may include obtaining synthetic queries. In some embodiments, the synthetic queries may be generated based on at least one document. For example, the processor may retrieve, from a database storing a document corpus, the at least one document. The at least one document may then be provided to an LLM to generate, based on the at least one document, the at least one synthetic query. To generate the at least one synthetic query, generation instructions may also be provided to the LLM along with the at least one document. The generation instructions may instruct the LLM to generate the queries based on the document such that the queries are answerable based on the document. The generation instructions may be, for example, “Generate questions that are answerable by these attached documents.” The processor may, in response to providing the at least one document to the LLM, receive the synthetic queries from the LLM. In some embodiments, the generation instructions may include an example query. For example, the generation instructions may include “Given the attached document, provide queries that are answerable by the attached document and similar to ‘I don't understand electromagnetism. Please help!’”

In some embodiments, the synthetic queries may be stored in a database. In such embodiments, the processor may receive, for example, from a computing device that maintains a RAG model, a model generation signal. The model generation signal may be a signal that causes the processor to train custom embeddings models and custom reranking models as seen in the distillation pipeline 500 of FIG. 5. Thus, in response to receiving the model generation signal, the processor may retrieve the queries from the database and trigger the obtaining or training of a custom embedding model or a custom reranking model.

Following the operation 1005, the method 1000 may proceed to an operation 1010. The operation 1010 may include associating a foundation embedding model and a foundation reranking model with a current model designation. The operation 1010 may be similar to the operation 710 as described herein with reference to FIG. 7.

Following the operation 1010, the method 1000 may proceed to an operation 1020. The operation 1020 may include generating, based on the models associated with the current model designation and the synthetic queries, a student embedding model and a student reranking model. The operation 1020 may be similar to the operation 720 of the method 700 of FIG. 7, the method 600 of FIG. 6, or the step 510-560 of FIG. 5.

The generating of the models in the operation 1020 may include distilling knowledge of the current models to the student models. In some embodiments, the distilling process may include providing the at least one synthetic query to one of the foundation models (say the foundation embedding model). The foundation model may include at least one activation function and, in response to receiving the at least one synthetic query, the foundation model may provide an output based on the at least one activation function. Parameters of a custom model (say a custom embedding model) may be modified based on the output.

Following the operation 1020, the method 1000 may proceed to an operation 1030. The operation 1030 may include associating the student embedding models and the student reranking model with the current model designation. The operation 1030 may be similar to the operation 730 as described herein with reference to FIG. 7.

Following the operation 1030, the method 1000 may proceed to a decision 1040. The decision 1040 include determining if a termination condition is satisfied. The decision 1040 may be similar to the decision 740 as described herein with reference to FIG. 7. If the termination condition is not satisfied at the decision 1040, the method 1000 may return to the operation 1020. Otherwise, the method 1000 may proceed to an operation 1050. The operation 1050 includes deploying models associated with the current model designation to a RAG model. The operation 1050 may be similar to the operation 750 of the method 700 as described herein with reference to FIG. 7.

In at least some implementations, the operations of the method 1000 may be performed using a common document corpus. In this way, the synthetic query data may be representative of questions that may occur based on that specific document corpus. This is also the same document corpus that is used during deployment. By generating the synthetic queries based on the same documents that are used to train the models and by then using that same document corpus after deployment in an operating environment such as with a chatbot, the trained models may identify documents from that document corpus that are highly relevant to an inputted particular query.

Synthetic query data, as used herein, refers to machine-generated query data. That is, the synthetic query data includes queries that are generated by a computer rather than by a human.

### Synthetic Query Generation

As described above, synthetic queries may be generated based on a document or document corpus. These queries may be used for training. A difficulty arises with synthetic query generation. Specifically, the synthetic queries may not be representative of real-life queries. Real-life queries may include, for example, typos, spelling errors, grammatical errors, unusual abbreviations, etc. Furthermore, such queries are often not in sentence format or even in the format of a question.

By way of example, below are sample real-life, or real, queries:
cx needs translation language
emt error codes
authentication procedure for signing authority on your account
wire info

Such informality problems often arise, for example, with chatbot deployments.

If an LLM were to be prompted to simply generate queries based on a document corpus, the queries that are generated may not, therefore, reflect typical real-life queries. Consequently, a model trained using such synthetic queries may not perform well when deployed in situations where the model is to be used in processing real-life queries.

The application herein proposes dynamic few-shot prompting to solve the problem described above. Dynamic few-shot prompting is the practice of providing an LLM with examples in addition to a prompt to enhance the quality of the output of the LLM. For example, if requesting the LLM to generate a poem in the Shakespearean style, an example of a Shakespearean poem may be provided to the LLM in addition to textual instructions such as “Generate a poem about gasoline in the Shakespearean style.” Dynamic few-shot prompting is dynamic in that the examples provided to the LLM may be determined dynamically as opposed to static few-shot prompting wherein the examples provided to the LLM are predetermined and unchanging for all inputs to the LLM.

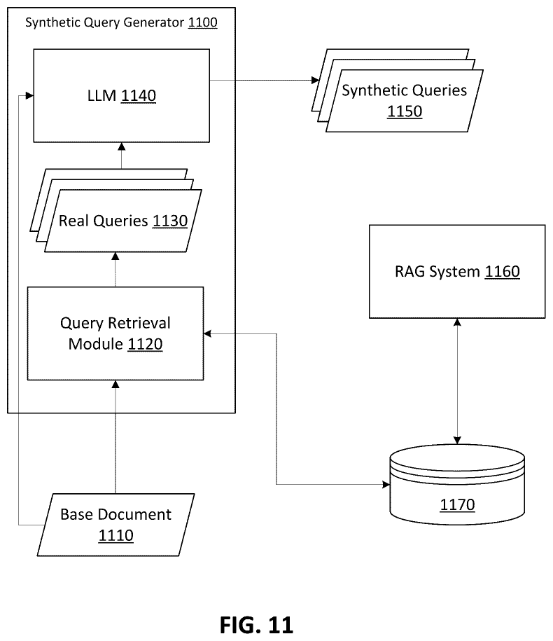

Reference is now made to FIG. 11 which shows a schematic diagram of a synthetic query generator 1100. The synthetics query generator 1100 may be provided by or on a server computer such as the server computer system 120. In at least some implementations, the synthetic query generator 1100 may be provided on multiple computer systems. These multiple computer systems may operate in a cooperative manner. In at least some implementations, one or more of the models or modules that are illustrated as being provided in the synthetic query generator 1100 may be, instead, be provided on another system, including a third-party system.

FIG. 11 shows the synthetic query generator 1100 receiving a base document 1110. In particular, a query retrieval module 1120 receives the base document 1110. The base document 1110 is a document for which synthetic queries will be generated. In some instances, the base document may be a new document that is added to a document corpus. In such instances, there may be a need to generate synthetic queries based on the base document 1110 to finetune the embedding model or the reranking model of a RAG model. It should be appreciated that the base document 1110 may be a vector representation of an underlying document. That is, the base document 1110 may be embeddings or embedding vectors in an embedding space. Further, while FIG. 11 illustrates one base document 1110, the synthetic query generator 1100 may be generalized to facilitate the processing of more than one base document.

The query retrieval module 1120 retrieves, from the database 1170, based on the base document, real queries 1130. Real queries are queries that were provided to a RAG or LLM by users thereof. The real queries may be stored, in the database 1170, in association with documents that they are related to. In some embodiments, the base document 1110, or vector representations there of, may be stored in the database 1170 in association with real queries. In these embodiments, the query retrieval module may perform, based on the base document 1110, a lookup operation in the database 1170 to retrieve these real queries that are associated with the base document 1110. These associated real queries may be included in the real queries 1130. In some embodiments, the query retrieval module 1120 may also retrieve real queries that are associated with documents of the document corpus that are similar to the base document 1110. To this end, the query retrieval module may use an embedding model or a reranking model, as described herein, to identify the similar documents. For example, the query retrieval module 1120 may identify, by comparing vector representations of the based document 1110 to vector representations of other documents in the document corpus, documents that are close or highly related to the base document 1110. That is, these close or highly related documents may be close or similar to the base document 1110 in the embedding space. The query retrieval module 1120 may then retrieve, from the database 1170, real queries that are stored in association with these close or highly related documents. These retrieved real queries may be included in the real queries 1130.

In some embodiments, the real queries 1130 may be textual. In other embodiments, the real queries 1130 may be vector representations or embeddings in the embedding space.

The synthetic query generator 1100 is further shown including an LLM 1140. The LLM 1140 receives the real queries 1130 and the base document 1110 and, in response thereto, generates synthetic queries 1150. The LLM 1140 may be provided, in addition to the base document 1110 and the real queries 1130, textual instructions that direct the LLM1140 to generate synthetic queries that are answerable or relevant to the base document 1110 and semantically or stylistically similar to the real queries 1130. An example such textual instructions is “Generate questions that are answerable by this attached document in the style of the provided real queries.”

The synthetic queries 1150 may be stored, in the database 1170, in association with the base document 1110.

FIG. 11 further shows a RAG system 1160. The RAG system 1160 may be a computer device or module that maintains a RAG model such as the RAG model 300 as described herein with reference to FIG. 3. The RAG system 1160 may maintain an interface for users to interact with the RAG model. The interface may be, for example, an AI chatbot. To this end, upon receiving a real query from a user of the AI chatbot, the RAG system, in generating a reply to the real query, may identify one or more documents in the document corpus that are relevant to the real query. The RAG system 1160 may then store, in the database 1170, the real query received via the AI chatbot (or another interface) in association with the identified one or more documents.

The database 1170 may store real queries and synthetic queries in association with documents of the document corpus. The base document 1110 may be included in the document corpus.

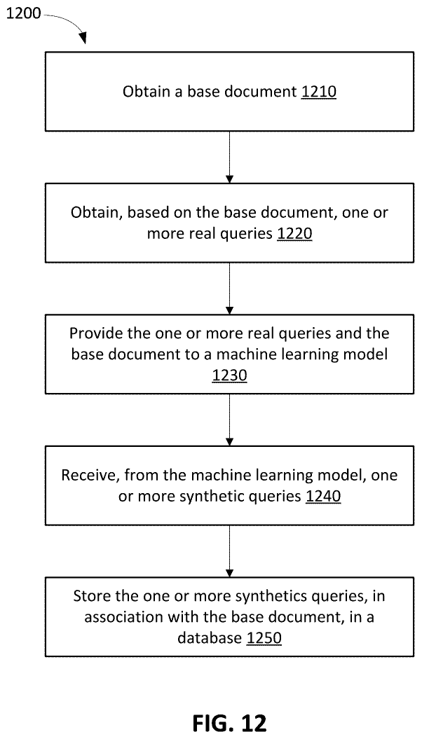

Reference is now made to FIG. 12 which shows an example method 1200 for generating improved synthetic queries. The method 1200 may, in least some implementations, be performed by one or both of a processor and a computer. For example, a memory may store instructions which, when executed, configure one or both of the processor and the computer to perform the method 1200 or a portion thereof.

The method 1200 may be performed to obtain synthetic queries. The synthetic queries may be paired with documents from which they were obtained. These synthetic queries may be used to train one or more models, as described above. Accordingly, the method 1200 may be performed prior to one or more of the methods 600 to 1000 of FIGS. 6 to 10.

The method 1200 may begin with an operation 1210. The operation 1210 may include obtaining a base document. The base document may be similar to the base document 1110 as described herein with reference to FIG. 11.

Following the operation 1210, the method 1200 may proceed to an operation 1220. The operation 1220 may include obtaining, based on the base document, one or more real queries. These obtained real queries may be similar to the real queries 1130 as described herein with reference to FIG. 11. Obtaining the one or more real queries may be similar to the retrieval of the real queries 1130 as performed by the query retrieval module 1120 of FIG. 11. For example, at least one of the one or more queries may be stored, in association with the base document, in a database. Accordingly, a lookup operation based on the base document may be performed to obtain the at least one of the one or more real queries. Additionally or alternatively, at least one of the one or more queries may be stored in the database in association with documents that are “similar” to the base document. Accordingly, obtaining the one or more real queries may include 1) identifying the similar documents and 2) performing a lookup operation, based on the similar documents, to obtain the at least one of the one or more real queries. It may be said that the processor obtains the one or more real queries based on: determining that one or more documents are similar to the base document; and determining that the one or more queries are associated with at least one of the base document and the one or more documents.

Following the operation 1220, the method 1200 may proceed to an operation 1230. The operation 1230 may include providing the one or more real queries and the base document to a machine learning model. The machine learning model may be similar to the LLM 1140 as described herein with reference to FIG. 11. In addition to providing the one or more real queries and the base document to the machine learning model, the operation 1230 may include providing textual instructions requesting the machine learning model to generate one or more synthetic queries based on one or more criteria. The criteria may include, for example, that the generated synthetic queries be semantically or stylistically similar to the real queries provided to the machine learning model, that the generated synthetic queries use similar words to the real queries, or that the generated synthetic queries be answerable based on the base document.

Following the operation 1230, the method 1200 may proceed to an operation 1240. The operation 1240 may include receiving, from the machine learning model, in response to providing the real queries and the base document the machine learning model, one or more synthetic queries. The synthetic queries may be similar to the synthetic queries 1150 as described herein with reference to FIG. 11.

Following the operation 1240, the method 1200 may proceed to an operation 1250. The operation 1250 may include storing the one or more synthetic queries, in association with the base document, in a database. At a later time, the stored synthetic queries may be used to train embeddings models or reranking models.

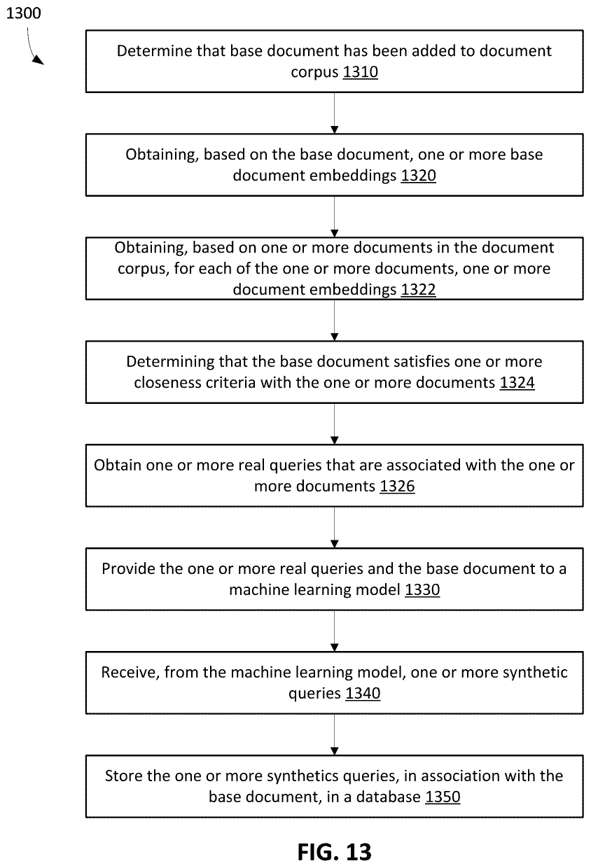

Reference is now made to FIG. 13 which shows, in flowchart form, a method 1300 for generating synthetic queries for a base document that has newly been added to a document corpus. The method 1300 may be considered a more specific implementation of the method 1200. The method 1300 may, in least some implementations, be performed by one or both of a processor and a computer. For example, a memory may store instructions which, when executed, configure one or both of the processor and the computer to perform the method 1300 or a portion thereof.

The method 1300 may be performed to obtain synthetic queries. The synthetic queries may be paired with documents from which they were obtained. These synthetic queries may be used to train one or more models, as described above. Accordingly, the method 1300 may be performed prior to one or more of the methods 600 to 1000 of FIGS. 6 to 10.

The method 1300 begins with an operation 1310. The operation 1310 includes determining that a base document has been added to a document corpus. In some embodiments, the processor may determine that the base document is new to the document corpus based on a timestamp associated with the base document. Additionally or alternatively, the processor may periodically maintain or interact with a record of the document corpus. During such a periodic interaction, the processor may identify a document identifier of the base document that was not in the document corpus previously. In response to determining that the base document has been added to the corpus, the processor may trigger a dynamic few-shot prompting process to generate synthetic queries based on the base document. That is, the processor may trigger the obtaining of real queries from the database and the obtaining of the synthetic queries.

Following the operation 1310, the method 1300 may proceed to an operation 1320. The operation 1320 may include obtaining, based on the base document, one or more base document embeddings. The one or more base document embeddings may be a vector representation of the base document in an embedding space. To this end, the base document embeddings may be obtained by providing the base document to an embedding model such as the embedding model 332 as described herein with reference to FIG. 3 or another similar machine learning model that processes or outputs embeddings. Additionally or alternatively, the base document embeddings may already be stored in a storage medium such as a database or a cache. In such instances, the base document embeddings may be obtained from the storage medium.

Following the operation 1320, the method 1300 may proceed to an operation 1322. The operation 1322 may include obtaining, based on one or more documents in the document corpus, for each of the one or more documents, one or more document embeddings. These document embeddings may also be in the embedding space. They may be obtained similarly to the one or more base document embeddings.

Following the operation 1322, the method 1300 may proceed to an operation 1324. The operation 1324 may include determining that the base document satisfies one or more closeness or similarity criteria with the one or more documents. In particular, the operation 1324 may include determining that, within the embedding space, the one or more base document embeddings and each of the one or more document embeddings satisfy one or more closeness or similarity criteria. The closeness or similarity criteria may include, for example, that the each of the one or more document embeddings are, in the embedding space, within a predefined distance or radius of the base document embeddings. In another example, the closeness or similarity criteria may include that, within the embedding space, each of the one or more document embeddings are the closest k document embeddings to the base document embeddings for some predetermined k. In another example, the closeness or similarity criteria may include that each inner product between the base document embeddings and a respective one of the document embeddings is below or above a predetermined threshold.

Following the operation 1324, the method 1300 may proceed to an operation 1326. The operation 1326 may include obtaining one or more real queries that are associated with the one or more documents. The real queries may be similar to the real queries 1130 as described herein with reference to FIG. 11.

The operations 1320 to 1326 may be considered to be a specific implementation of the operation 1220 of the method 1200 as described herein with reference to FIG. 12. It should be appreciated that while the operations 1320 to 1326 use an embedding model-based approach to obtaining the one or more real queries, in other embodiments, a reranking model-based or cross-encoder-based approach may be used. In other embodiments, similar to a RAG model, both an embedding model and a reranking model may be used to identify the one or more documents.

Following the operation 1326, the method 1300 may proceed to an operation 1330. The operation 1330 may include providing the one or more real queries and the base document to a machine learning model. The operation 1330 may be similar to the operation 1230 of the method 1200.

Following the operation 1330, the method 1300 may proceed to an operation 1340. The operation 1340 may include receiving, from the machine learning model, one or more synthetic queries. The operation 1340 may be similar to the operation 1240 of the method 1200.

Following the operation 1340, the method 1300 may proceed to an operation 1350. The operation 1350 may include storing the one or more synthetic queries, in association with the base document, in a database. The operation 1350 may be similar to the operation 1250 of the method 1200.

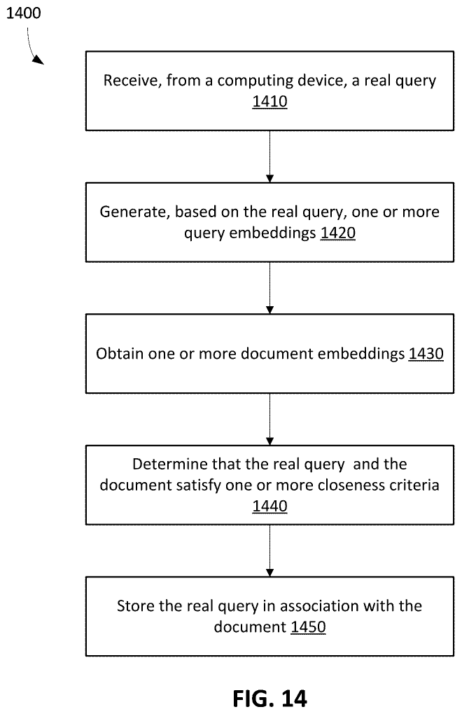

As discussed when describing the RAG system 1160 of FIG. 11, real queries may be collected from users interacting with a RAG model or LLM. Reference is now made to FIG. 14 which shows, in flowchart form, a method 1400 for storing real queries in association with documents in a document corpus. The method 1400 may, in least some implementations, be performed by one or both of a processor and a computer. For example, a memory may store instructions which, when executed, configure one or both of the processor and the computer to perform the method 1400 or a portion thereof. In particular, the method 1400 may be performed by a computer that maintains an interface for interacting with a RAG model that retrieves documents from a document corpus. That is, the computer may maintain a connection to a computing device via an interface.

The method 1400 begins with an operation 1410. The operation 1410 includes receiving, from the computing device, a real query. The real query may be received over the connection to the computing device. Further the real query may be received as inputs to a RAG model maintained by the computer.

Following the operation 1410, the method 1400 may proceed to an operation 1420. The operation 1420 may include generating, based on the real query, one or more query embeddings in an embedding space. The query embeddings may be a vector representation of the query. The query embeddings may be generated as part of a document retrieval process of the RAG model maintained by the computer.

Following the operation 1420, the method 1400 may proceed to an operation 1430. The operation 1430 may include obtaining one or more document embeddings generated based on a document in the document corpus. The one or more document embeddings may also be in the embedding space. In some embodiments, the document may be retrieved from a database storing the document corpus and input into an embedding model to obtain the one or more document embeddings. In other embodiments, the one or more document embeddings may be computed beforehand and stored in a storage medium such as a cache. In such embodiments, the one or more document embeddings may be retrieved from the storage medium. The one or more document embeddings may be obtained as part of the retrieval operation of the RAG model.

Following the operation 1430, the method 1400 may proceed to an operation 1440. The operation 1440 may include determining that the real query and the document satisfy one or more closeness or similarity criteria. That is, the operation 1440 may include determining that the query embeddings and the document embeddings satisfy one or more closeness or similarity criteria within the embedding space. The closeness or similarity criteria may include, for example, that the inner product of the query embedding and the document embedding are above or below a predefined threshold. It may be said that by determining that the one or more closeness or similarity criteria is satisfied, the operation 1440 includes determining that the query is associated with or related to the document.

It should be appreciated that while the operations 1420-1430 describe an embedding model-based approach to determining relevance or similarity of the query to the one or more documents, in other embodiments, a reranking model may also be used. For example, determining relevance of the query to the one or more documents may be a matter of having the RAG model retrieve the one or more documents (using an embedding model and a reranking model) based on the query.

Following the operation 1440, the method 1400 may proceed to an operation 1450. The operation 1450 may include storing the real query in association with the document.

Since, in the method 1400, the real query was related to the document, it may be said that the query was received in association with the document.

It should be appreciated that while the method 1400 is described using one query and one document, the method 1400 may be generalized to apply to multiple real queries and multiple documents.

### Chain of Thought Optimization

Methods of training a reranker or reranking model will be described. Some of the methods described herein may use a reranker that is trained according to such methods or may include operations of training a reranker according to such methods.

Generally, RAG systems require fast reranking models in order to order documents based on semantic similarity to a user query. Typically, RAG systems require fast pointwise rerankers. Pointwise rerankers score each item separately. Such rankers typically use regression or classification models, such as logistic regression or BERT-based classifiers. A problem that sometimes arises with pointwise rerankers is that the compute power of pointwise rerankers is limited and it is not possible to increase compute power at test-time to deliberate which documents are relevant to the query. Methods described herein may, in at least some implementations, address one or more such problems with existing reranking models.

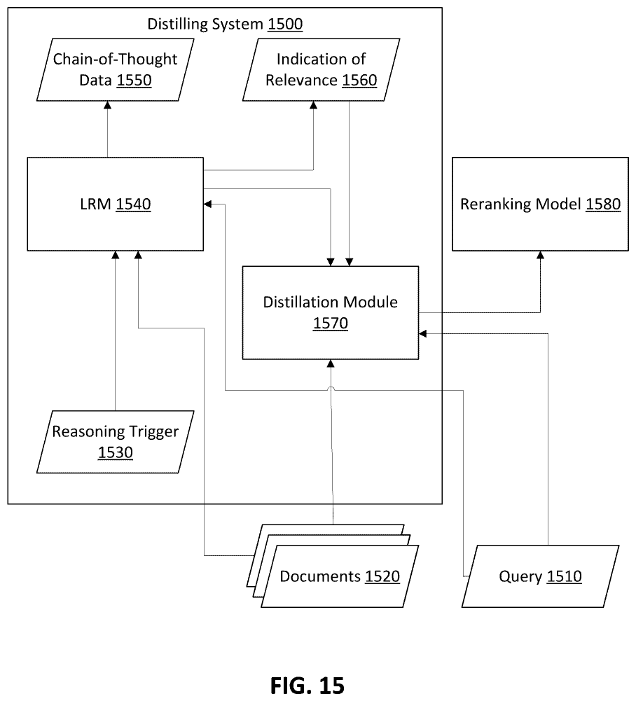

Reference is now made to FIG. 15 which shows a schematic diagram of a distilling system 1500. The distilling system 1500 may be used to train a reranking model 1580 via distillation. In particular, the distillation involves distilling the knowledge of a large reasoning model (LRM) 1540 to the reranking model 1580. The distilling system 1500 may be provided by or on a server computer such as the server computer system 120. In at least some implementations, the distilling system 1500 may be provided on multiple computer systems. These multiple computer systems may operate in a cooperative manner. In at least some implementations, one or more of the models or modules that are illustrated as being provided in the synthetic query generator 1100 may be, instead, be provided on another system, including a third-party system.

FIG. 15 shows a query 1510. The query 1510 may be a textual query such as a prompt to a LLM or RAG model. FIG. 15 shows documents 1520. In some embodiments, the query 1510 may be a synthetic query. In some embodiments, the query 1510 may be a real query obtained from a user interacting with a RAG model or an LLM. The documents 1520 may be documents belonging to a document corpus.

FIG. 15 shows the distilling system 1500 including the LRM 1540. The LRM 1540 is an advanced machine learning based AI model that specializes in complex reasoning task, such as logical inference, mathematical problem-solving, decision making, and multi-step reasoning. The LRM 1540 may be optimized for structured thought process and multi-step reasoning. The LRM 1540 may be trained using reinforcement learning on logical tasks to produce chains of thought and ordering information. The LRM 1540 is shown receiving the query 1510, the documents 1520, and a reasoning trigger 1530. The reasoning trigger 1530 may be thought of as instructions to the LRM 1540 that cause the LRM 1540 to generate chain-of-thought data 1550. The chain-of-thought data 1550 may be a series of logical steps that explain the LRM 1540's reasoning for generating the output that it did. More specifically, the Chain-of-thought data 1550 may explicitly indicate intermediate reasoning steps that lead to the final answer for the LRM 1540. The chain-of-thought data 1550 may also, in some cases, be referred to as one or more of: step-wise reasoning data, decision making data, path data, reasoning data, step-by-step reasoning data, justification data, reasoning trace data or output trace data. In addition to the query 1510, the documents 1520, and the reasoning trigger 1530, textual instructions instructing the LRM 1540 to output an ordering of the documents 1520 based on relevance to the query 1510, may be provided to the LRM 1540. An example of such textual instructions is “Order the provided documents based on relevance to the provided query.” Thus, the LRM 1540 may be configured to output the chain-of-thought data 1550 wherein the chain-of-thought-data 1550 is a series of logical steps explaining the LRM 1540's reasoning for its determined ordering of the documents 1520.

In some embodiments, the reasoning trigger 1530 may include textual instructions. For example, the reasoning trigger 1530 may be “provide a step-wise chain of reasoning to explain why the ordering output by you [the LRM 1540] is correct.”

The LRM 1540 may also be configured to output, based on the query 1510, the documents 1520, the reasoning trigger 1530, and the instructions, an indication of relevance 1560. The indication of relevance 1560 may be data that indicates the ordering of the documents 1520 as determined by the LRM 1540. In some embodiments, the indication of relevance 1560 may include a final output of the LRM 1540. For example, the indication of relevance 1560 may include the ordering information of the documents 1520 that is output by the LRM 1540. In other embodiments, the indication of relevance 1560 may be outputs of hidden layers of the LRM 1540 that the LRM 1540 computes on route to outputting a final ordering of the documents 1520. For example, the indication of relevance 1560 may include logits that have been computed internally by the LRM 1540 based on at least the query 1510, the documents 1520, and the reasoning trigger 1530. In some embodiments, the indication of relevance 1560 may include an ordering of all of the documents 1520. In other embodiments, the indication of relevance may include an ordering of, for example, the top k most relevant documents from the documents 1520.

The distillation module 1570 may cause distillation/training of the reranking model 1580. In particular, the distillation module may train the ranking model 1580 based on the query 1510, the documents 1520, and the indication of relevance 1560. That is, knowledge of the LRM 1540 with respect to ordering the documents 1520 based on relevance to the query 1510 may be transferred to the reranking model 1580. Techniques used in the distillation process may include, without limitation, logits distillation, temperature-scaled knowledge distillation, margin-based loss, or other distillation techniques.

In some embodiments, the reranking model 1580 may be a pointwise reranker. A pointwise reranker is a type of ranking model that scores each document in a query-document pair independently, without considering the relative ranking of other documents. Unlike pairwise or listwise rerankers, which compare multiple candidates simultaneously, a pointwise reranker assigns a relevance score to each document based solely on its content and the query. These models are commonly used in search engines, recommendation systems, and information retrieval tasks, including RAG systems, where they refine initial search results by assigning more precise relevance scores. Pointwise rerankers may be trained using labeled data, where each document may be assigned a relevance score or classification label (e.g., relevant, not relevant) (in this case by the LRM 1540).

It should be appreciated that the chain-of-thought data 1550 may not be used in the distillation process to distill the reranking model 1580. In such embodiments, it may be interpreted that the reasoning trigger 1530, which causes the LRM 1540 to output the chain-of-thought data 1550, enhances the quality of the indication of relevance 1560. In some embodiments, it may be said that the reasoning trigger 1530 causes the LRM 1540 to solves a more difficult task than a simple ordering of documents and, as such, enhances the quality of the indication of relevance 1560. Thus, in these embodiments, the chain-of-thought data 1550 may be thought of as a biproduct of enhancing the quality of the indication of relevance 1560. By causing the LRM 1540 to output the chain-of-thought data 1550, the training data that is used to train the reranking model 1580 may be improved which may improve the performance of the reranking model 1580.

In other embodiments, the distillation module 1570 may also incorporate the chain-of-thought data 1550 into training the reranking model 1580. That is, the distillation module 1570 may modify parameters of the reranking model 1580 based on the chain-of-thought data 1550 in addition to the indication of relevance 1560.

In some embodiments, the query 1510 or the documents 1520 may be embeddings in an embeddings space.

It should be appreciated that the LRM 1540 may be defined according to LRM parameters, the LRM parameters numbering more than the parameters of the reranking model 1580.

While FIG. 15 shows, for simplicity, the one query 1510, it should be appreciated that the distilling system 1500 may be generalized to train the reranking model 1580 using more than one query.

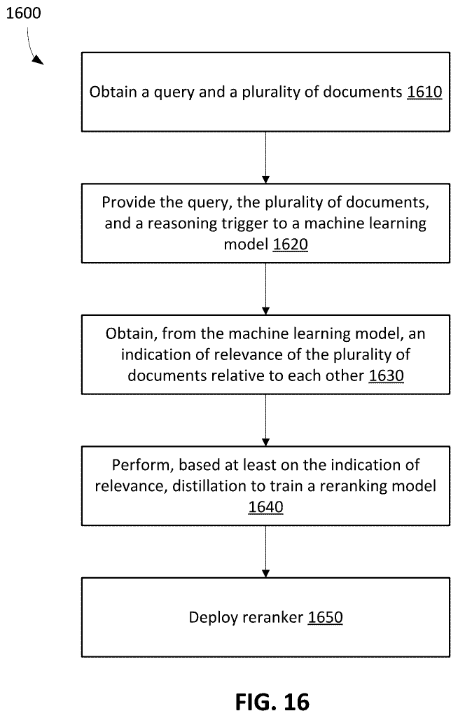

Reference is now made to FIG. 16 which shows, in flowchart form, a method 1600 for distilling a reranking model by using chain-of-thought data. The method 1600 may, in least some implementations, be performed by one or both of a processor and a computer. For example, a memory may store instructions which, when executed, configure one or both of the processor and the computer to perform the method 1600 or a portion thereof. The method 1600 may be executed by, for example, the distilling system 1500, as described herein with reference to FIG. 15.

The method 1600 begins with an operation 1610. The operation 1610 may include obtaining a query and a plurality of documents. The query may be similar to the query 1510 as described herein with reference to FIG. 15. The plurality of documents may be similar to the documents 1520 as described herein with reference to FIG. 15.

Following the operation 1610, the method 1600 may proceed to an operation 1620. The operation 1620 may include providing the query, the plurality of documents, and a reasoning trigger to a machine learning model. The machine learning model may be similar to the LRM 1540 as described herein with reference to FIG. 15. The reasoning trigger may be similar to the reasoning trigger 1530 as described herein with reference to FIG. 15. That is, the reasoning trigger may instruct the machine learning model to process or output chain-of-though data. In some embodiments, the reasoning trigger may cause the machine learning model to output at least a portion of the chain-of-thought data. The chain-of-thought data may be similar to the chain-of-thought data 1550 as described herein with reference to FIG. 15. The machine learning model may further be provided with textual instructions instructing the machine learning model to produce an ordering of the plurality of documents based on relevance to the query.

Following the operation 1620, the method 1600 may proceed to an operation 1630. The operation 1630 may include obtaining, in response to providing the query and the plurality of documents to the machine learning model, from the machine learning model, an indication of relevance of the plurality of documents relative to each other. The indication of relevance may be similar to the indication of relevance 1560 as described herein with reference to FIG. 15. That is, the indication of relevance may indicate an ordering of the plurality of documents based on relevance to the query. In some embodiments, the indication of relevance may include intermediate outputs of the machine learning model resulting from the machine learning model processing, the query, the plurality of documents, and/or the chain-of-thought data.

Following the operation 1630, the method 1600 may proceed to an operation 1640. The operation 1640 may include performing, based at least on the indication of relevance, distillation to train a reranking model. That is, the operation 1640 may include modifying, based at least on the indication of relevance, parameters of the reranking model. Put another way, the operation 1640 may include distilling knowledge of the machine learning model, with respect to the query and the plurality of documents, to the reranking model.

Following the operation 1640, the method 1600 may proceed to an operation 1650. The operation 1650 may include deploying the reranking model to be used in a RAG model such as the RAG model 300 as described herein with reference to FIGS. 3A and 3B. The RAG model may be used as part of an AI application.

According to the method 1600 of FIG. 16, a larger reasoning model that generates path data may be used to produce data that may be used to distill into a reranking model. This may render the reranking model both efficient and small. Further, the reranking model may produce better results than alternative ranking techniques, such as random negative sampling.

Modifying Colbert with Self-Attention Layer

ColBERT (Contextualized Late Interaction over BERT) is an information retrieval model that enhances search ranking by leveraging deep contextual embeddings while maintaining computational efficiency. Instead of relying on a single vector to represent queries and documents, ColBERT computes similarity scores between them using token embeddings. This allows it to preserve word-level context and interactions, unlike traditional dense retrieval methods that rely on a single embedding per document. By using BERT-based token representations, ColBERT captures nuanced semantic relationships, which may improve retrieval accuracy compared to keyword-based approaches.

The model employs a late interaction mechanism called MaxSim, which compares each query token embedding with all document token embeddings and selects the maximum similarity score. This reduces the need for exhaustive pairwise comparisons while still capturing token-level relationships. Document token embeddings are precomputed and stored on disk, then loaded into memory at inference time, while query token embeddings are computed on the fly. This design enables efficient retrieval by avoiding the computationally expensive process of re-encoding or re-embedding entire documents for each query.

Because similarity computation in ColBERT requires matrix multiplication, it differs from traditional dense retrieval methods that typically use simple dot product or cosine similarity. By balancing precomputed document embeddings with efficient query-time interaction, ColBERT offers a scalable solution which may be used with large-scale applications such as web search, enterprise document retrieval, and domain-specific information retrieval in financial, legal and medical fields. The combination of efficiency and effectiveness makes it a practical alternative to fully cross-encoder-based retrieval models.

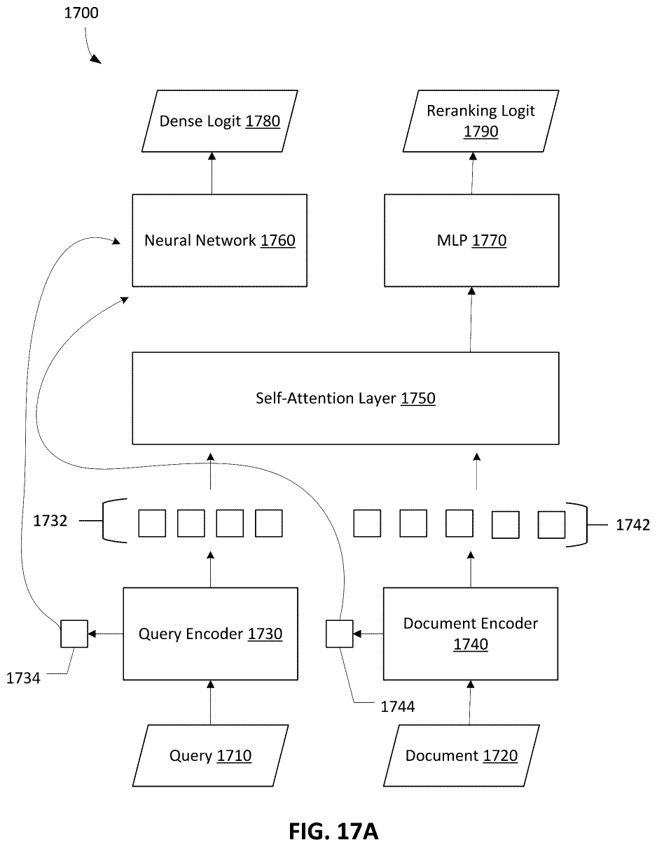

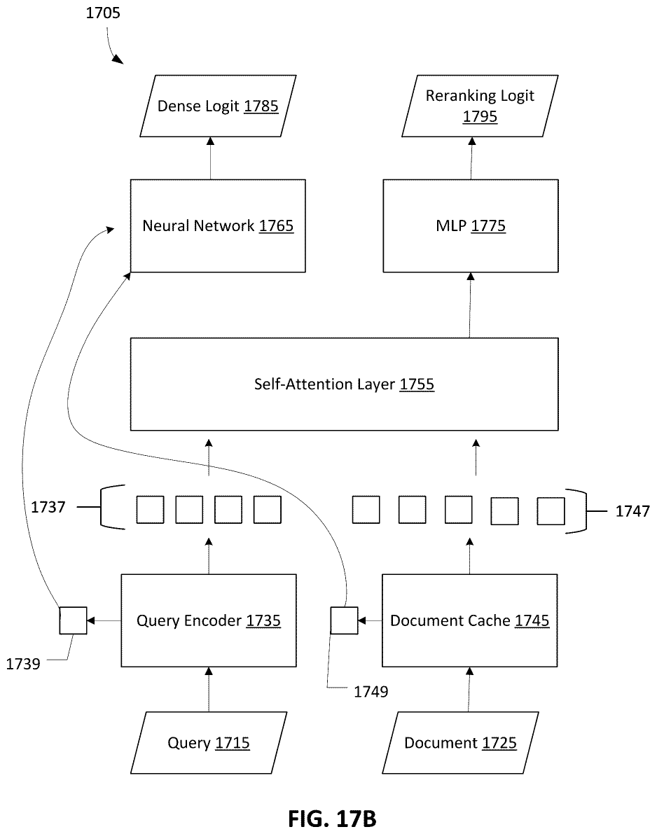

Reference is now made to FIG. 17A which shows a diagram of an architecture 1700 of a reranking model obtained by modifying ColBERT by replacing the MaxSim mechanism with a self-attention layer 1750. The architecture 1700 may be provided by or on a server computer such as the server computer system 120. In at least some implementations, the architecture 1700 may be provided on multiple computer systems. These multiple computer systems may operate in a cooperative manner. In at least some implementations, one or more of the models or modules that are illustrated as being provided in the architecture 1700 may be, instead, be provided on another system, including a third-party system. The self-attention layer 1750 may effectively act as a lightweight cross-encoder. Thus, the modifications to ColBERT shown in FIG. 17A may result in a more computationally efficient version of ColBERT.

FIG. 17A shows the architecture 1700 including a query encoder 1730 and a document encoder 1740. The query encoder 1730 may be a BERT-based encoder. The query encoder 1730 may receive a query 1710 and output a dense query embedding 1734 and one or more query embeddings 1732. Likewise, the document encoder 1740 may be a BERT-based encoder. The document encoder 1740 may receive a document 1720 and output a dense document embedding 1744 and one or more document embeddings 1742. In some embodiments, the query encoder 1730 and the document encoder 1740 may be the same encoder. It should be appreciated that while FIG. 17A shows 4 query embeddings 1732 and 5 document embedding 1742, there may be more or less such embeddings.

The dense query embedding 1734 is an embedding that encapsulates the query 1710 in one embedding. Likewise the dense document embedding 1744 is an embedding that encapsulates the document 1720. FIG. 17A shows the dense query embedding 1734 and the dense document embedding 1744 being provided to a neural network 1760. The neural network 1760 outputs, in response to receiving the dense query embedding 1734 and the dense document embedding 1744, a dense logit 1780.

While computing the dense logit 1780 involves loss of information because the query 1710 is compressed to the dense query embedding 1734 and the document 1720 is compressed to the dense document embedding 1744, the lack of embeddings involved in computing the dense logit 1780 results in an efficient computation. Accordingly, the dense logit 1780 may be considered an initial understanding of the relevance of the document 1720 to the query 1710 without the fine-grained analysis provided by a cross-encoder.

It is noted that the query embeddings 1732 number more than the dense query embedding 1734 and, as such, the query embeddings 1732 may capture more information about the query 1710 than the dense query embedding 1734. Likewise, the document embeddings 1742 may capture more information about the document 1720 than the dense document embedding 1744.

After the document encoder 1740 outputs the dense document embedding 1744 and the document embeddings 1742, the dense document embedding 1744 and the document embeddings 1742 may be stored in a cache (not shown in FIG. 17A). Thus, for future use of the document 1720, the dense document embedding 1744 and the document embeddings 1742 may be directly retrieved from the cache. This use of the cache eliminates the future need to compute the dense document embedding 1744 and the document embeddings 1742, thereby reducing computational overhead in the future.

FIG. 17A further shows the query embeddings 1732 and the document embeddings 1742 being provided to a self-attention layer 1750. The self-attention layer 1750 receives the query embeddings 1732 and the document embeddings 1742 at once. That is, the self-attention layer 1750 processes the query embeddings 1732 together with the document embeddings 1742. The self-attention layer 1750 may treat the query embeddings 1732 and the document embeddings 1742 as one single sequence of embeddings. Based on this single sequence of embeddings, the self-attention layer 1750 may determine a query matrix, a key matrix, and a value matrix based on learned weighted transformations. That is, a first weighted transformation may be used to determine the query matrix, a second weighted transformation may be used to determine the key matrix, and a third weighted transformation may be used to determine the value matrix. Specifically, given an input sequence (X₁, . . . , X_{N}) of d-dimensional vectors, the self-attention layer 1750 may stack vectors into a N×d matrix X. The self-attention layer 1750 may then compute the query matrix Q, the key matrix K and, the Value matrix V according to:

$$Q = {XW}^{Q} , K = {XW}^{K} , V = {XW}^{V}$$

wherein W^{Q}, W^{K}, W^{V} are the learned weighted transformations. The self-attention layer 1750 may then determine its output Y according to the following normalized linear transformation:

$$Y = softmax ( \frac{{QK}^{T}}{\sqrt{d}} ) V .$$

FIG. 17A further shows the output of the self-attention layer 1750 being provided to a multilayer perceptron (MLP) 1770. The MLP 1770 outputs, based on the input from the self-attention layer 1750, a reranking logit 1790.

In the context of inference, the reranking model with the architecture 1700 may determine the relevance of the document 1720 to the query 1710 based on the reranking logit 1790 and/or the dense logit 1780.

In the context of training, parameters of the query encoder 1730, the document encoder 1740, the self-attention layer 1750, the neural network 1760, and/or the MLP 1770 may be modified based on a RankNet learning algorithm. The RankNet learning algorithm may be applied by computing loss from the dense logit 1780 and/or the reranking logit 1790.

Reference is now made to FIG. 17B which shows a diagram of an architecture 1705 of a reranking model obtained by modifying ColBERT by replacing the MaxSim mechanism with a self-attention layer 1755. The architecture 1705 may be provided by or on a server computer such as the server computer system 120. In at least some implementations, the architecture 1705 may be provided on multiple computer systems. These multiple computer systems may operate in a cooperative manner. In at least some implementations, one or more of the models or modules that are illustrated as being provided in the architecture 1705 may be, instead, be provided on another system, including a third-party system.

The architecture 1705 is similar to the architecture 1700 as described herein with reference to FIG. 17A. FIG. 17B shows a query 1715, a document 1725, a query encoder 1735, query embeddings 1737, a dense query embedding 1739, document embeddings 1747, a dense document embedding 1749, a self-attention layer 1755, a neural network 1765, a MLP 1775, a dense logit 1785, and a reranking logit 1795, all of which are respectively similar to the query 1710, the document 1720, the query encoder 1730, the query embeddings 1732, the dense query embedding 1734, the document embeddings 1742, the dense document embedding 1744, the self-attention layer 1750, the neural network 1760, the MLP 1770, the dense logit 1780, and the reranking logit 1790 as described herein with reference to FIG. 17A.

The architecture 1705 differs from the architecture 1700 in that the architecture 1705 includes a document cache 1745 instead of a document encoder 1740. The document cache 1745 stores the document embeddings 1747 and the dense document embedding 1749 which have been precomputed. Storing the precomputed document embeddings 1747 and the precomputed dense document embedding 1749 in the cache reduces the computational overhead of generating the document embeddings 1747 or the dense document embedding 1749 at inference time. It also allows the document embeddings 1747 and the dense document embedding 1749 to be computed offline without interacting with a query, such as the query 1715, in any way. For example, in the case that the architecture 1705 is used in an online AI application that uses a RAG model, the document embeddings 1747 and the dense document embedding 1749 may be computed offline prior to receiving a user query through the application.

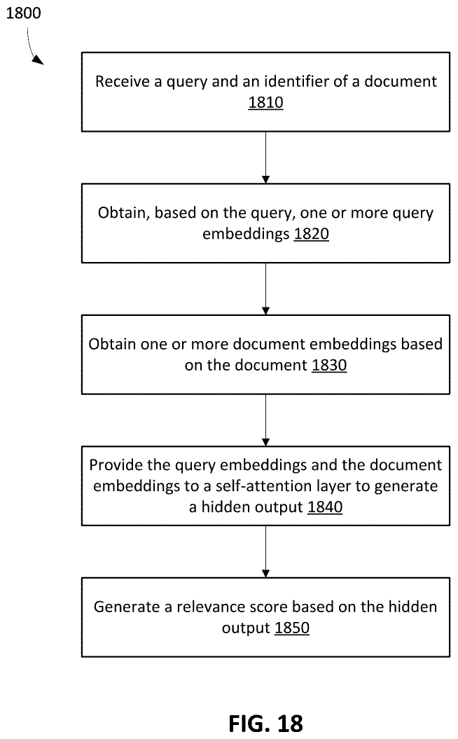

Reference is now made to FIG. 18 which shows, in flowchart form, a method 1800 for determining a relevance score based on a query and a document. The method 1800 may, in least some implementations, be performed by one or both of a processor and a computer. For example, a memory may store instructions which, when executed, configure one or both of the processor and the computer to perform the method 1800 or a portion thereof. The method 1800 may be executed by, for example, a computer system that provides a reranking model with an architecture such as the architecture 1700 or the architecture 1705 as described herein with reference to FIGS. 17A and 17B. Put another way, the method 1800 may considered to, at least partially, implement the architectures 1700 or 1705.

The method 1800 begins with an operation 1810. The operation 1810 includes receiving a query and an identifier of a document. The query may be similar to the queries 1710 or 1715 of FIGS. 17A and 17B. Likewise the document may be similar to the documents 1720 and 1725 of FIGS. 17A and 17B. For example, the document may be a document of a document corpus. The identifier may be data that can be used to identify the document. Put another way, the identifier could be used to, for example, retrieve the document or embeddings of the document from a database or cache.

Following the operation 1810, the method 1800 may proceed to an operation 1820. The operation 1820 may include obtaining, based on the query, one or more query embeddings. The query embeddings may be in an embedding space. Obtaining the one or more query embeddings may include providing the query to a query encoder such as the query encoders 1730 or 1735 of FIGS. 17A and 17B.

Following the operation 1820, the method 1800 may proceed to an operation 1830. The operation 1830 may include obtaining one or more document embeddings based on the document. In some embodiments, obtaining the one or more document embeddings may include providing the document to a document encoder to generate the one or more document embeddings based on the document. In some embodiments, the generating of the one or more document embeddings may be performed to obtain the document embeddings at a later time. In these embodiments, after generation, the document embeddings may be stored in a cache and obtaining the one or more document embeddings at a later time may involve retrieving the document embeddings from the cache based on the identifier of the document.

Following the operation 1830, the method 1800 may proceed to an operation 1840. The operation 1840 may include providing the query embeddings and the document embeddings to a self-attention layer to generate a hidden output (or intermediate output). The self-attention layer may act as a cross-encoder that processes the query embeddings and the document embeddings together as a sequence. The self-attention layer may be similar to the self-attention layers 1750 or 1755 of FIGS. 17A and 17B. The self-attention layer may generate the hidden output in response to receiving the query embeddings and the document embeddings.

Following the operation 1840, the method 1800 may proceed to an operation 1850. The operation 1850 may include generating a relevance score based at least on the generated hidden output. The generating of the relevance score may include providing the hidden output to a machine learning model to generate the relevance score. The machine learning model may be an MLP.

In some embodiments, the relevance score may also be generated based on a dense logit. Specifically, the processor may obtain a dense query embedding based on providing the query to a query encoder. The processor may also obtain a dense document embedding based on the document. In some embodiments, the dense document embedding may be obtained by providing the document to a document encoder to generate the dense document embedding. In other embodiments, the dense document may be precomputed by the document encoder and stored in a cache. In such embodiments, the processor may directly retrieve the dense document embedding from the cache. The processor may further obtain, based on the dense query embedding and the dense document embedding, a dense logit. To this end, the dense query embedding and the dense document embedding may be provided to a neural network to output the dense logit. Further, the output of the MLP may be a reranking logit and the relevance score may be determined based on the dense logit and the reranking logit. For example, the relevance score may be a linear combination of the dense logit and the reranking logit.

It should be appreciated that the method 1800 may be generalized to process more than one query and more than one document.

It should further be appreciated that the relevance score generated in the operation 1850 may be used to, in the context of running or using a reranking model, determine the relevance of the document relevant to the query. Accordingly, the relevance score generated in the operation 1850 may be used in a reranking operation wherein the document is scored and/or reranked relative to other documents in the document corpus. In some embodiments, based on the generated relevance score, the processor may determine that the document is relevant to the query and, in response thereto, provide the query and the document to an LLM of a RAG model to generate an output. In other embodiments, the processor may determine that the document is not relevant, or not relevant enough, and refrain from providing the document to an LLM of a RAG model. It should be appreciated that if the processor determines that the document is relevant to the query, instead of the document, the processor may provide, to the LLM, the identifier of the document, the document embeddings, or other data representative of the document. Hence, in such scenarios, it may be said that the processor provides data based on the document to the LLM.

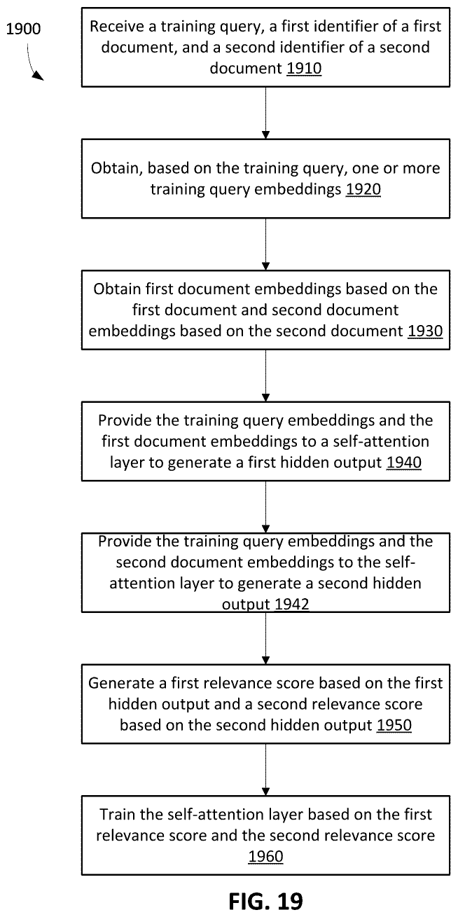

Reference is now made to FIG. 19 which shows, in flowchart form, a method 1900 for training a ColBERT model that has been modified by replacing the MaxSim mechanism with a self-attention layer. The method 1900 may, in least some implementations, be performed by one or both of a processor and a computer. For example, a memory may store instructions which, when executed, configure one or both of the processor and the computer to perform the method 1900 or a portion thereof. The method 1900 may be executed by, for example, a computer system that provides a reranking model with an architecture such as the architecture 1700 or the architecture 1705 as described herein with reference to FIGS. 17A and 17B.

The method 1900 may begin with an operation 1910. The operation 1910 may include receiving a training query, a first identifier of a first document, and a second identifier of a second document. The training query and the first identifier of the first document may be similar to the query and the identifier of the document as described herein with reference to the method 1800 of FIG. 18. The first document and the second document may both be part of the same document corpus. The second identifier may be data that can be used to identifier the document. The second identifier may be used to, for example, retrieve the second document, or its corresponding document embeddings, from a cache or database.

Following the operation 1910, the method 1900 may proceed to an operation 1920. The operation 1920 may include obtaining, based on the training query, one or more training query embeddings. The operation 1920 may be similar to the operation 1820 as described herein with reference to FIG. 18. The training query embeddings may be similar to the query embeddings 1732 or 1735 as described herein with reference to FIGS. 17A and 17B.

Following the operation 1920, the method 1900 may proceed to an operation 1930. The operation 1930 may include, obtaining first document embeddings based on the first document and second document embeddings based on the second document. The obtaining of the first document embeddings and the second document embeddings may be performed similarly to the operation 1830 of the method 1800 as described herein with reference to FIG. 18. It may be said that the operation 1930 is a repeated performance of the operation 1830; one performance for the first document and another performance for the second document.

Following the operation 1930, the method 1900 may proceed to an operation 1940. The operation 1940 may include providing the training query embeddings and the first document embeddings to a self-attention layer to generate a first hidden output. The operation 1940 may be performed similar to the operation 1840 of the method 1800 as described herein with reference to FIG. 18.

Following the operation 1940, the method 1900 may proceed to an operation 1942. The operation 1942 may include providing the training query embeddings and the second document embeddings to the self-attention layer to generate a second hidden output. The operation 1942 may be performed similarly to the operation 1940. It should be appreciated that the operations 1940 and 1942 may be performed in any order or simultaneously. As described herein with reference to the operation 1840 of the method 1800, the first document embeddings and the second document embeddings may be stored and retrieved from a cache.

Following the operation 1942 (or 1940), the method 1900 may proceed to an operation 1950. The operation 1950 may include generating a first relevance score based on the hidden output and a second relevance score based on the second hidden output. The generating of the first relevance score and the second relevance score may be similar to the generating of the relevance score in the operation 1850 of the method 1800 as described herein with reference to FIG. 18. That is, the first relevance score may be generated by providing the first hidden output to a machine learning model. Likewise, the second relevance score may be generated by providing the second hidden output to the machine learning model.

Following the operation 1950, the method 1900 may proceed to an operation 1960. The operation 1960 may include training the self-attention layer based on the first relevance score and the second relevance score. To this end, the processor may use RankNet loss and/or the RankNet learning algorithm to train the self-attention layer. That is, the processor may perform the RankNet learning algorithm using the first relevance score and the second relevance score.

In some embodiments, the first relevance score and the second relevance may be generated based on, in addition to the hidden output and the second hidden output, a first dense logit and a second dense logit. In such embodiments, the processor may obtain a dense training query embedding by providing the query to a query encoder. The processor may further obtain a first dense document embedding based on the document. The processor may further obtain a second dense document embedding based on the second document. The process may further obtain, based on the dense training query embedding and the first dense document embedding, a dense logit. The processor may further obtain, based on the dense query embedding and the second dense document embedding, a second dense logit. The dense embeddings may be provided to a neural network to obtain the dense logit or the second dense logit. The first relevance score may then be generated, based on, in addition to the hidden output, the dense logit. Likewise, the second relevance score may then be generated based on, in addition to the second hidden output, the second dense logit.

### Applying Colbert Loss to Fine Tuning LLM Text Encoder

Existing ColBERT models have been trained on BERT-family architectures, which have a relatively lower number of parameters and, as a result, limited representation capability. For example, ColBERT is often built on BERT-base which has a limitation of 110 million parameters. In contrast, many LLMs may have hundreds of billions of parameters. For example, GPT-3 has 175 billion parameters.

While BERT-based models perform well in retrieval tasks, their expressiveness is constrained compared to LLMs. This limitation affects their ability to capture complex relationships in text, which is crucial for high-accuracy information retrieval.

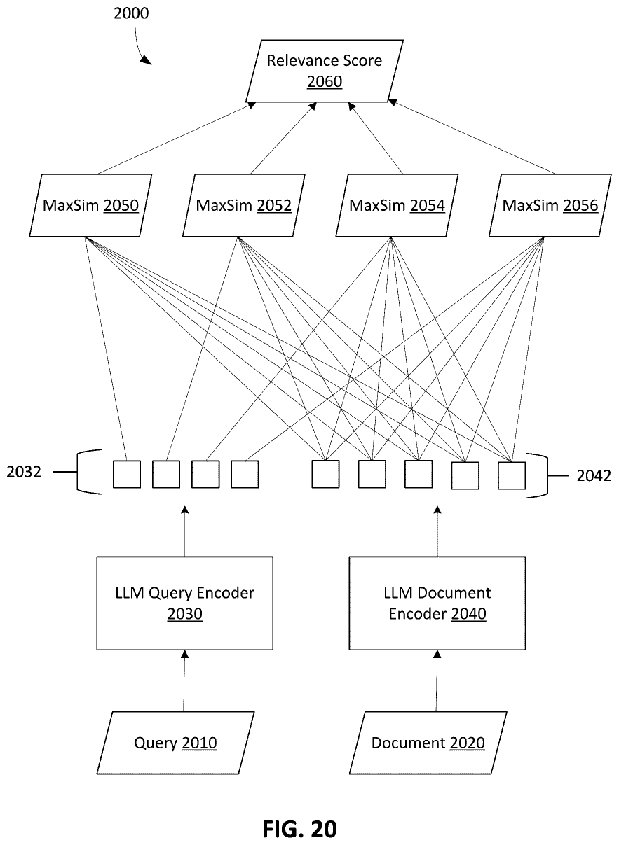

The issues of ColBERT outlined above may be solved by replacing the BERT-base encoders with LLMs that have been converted into encoders. Reference is now made to FIG. 20 which shows an architecture 2000 of a reranking model that uses LLM encoders to generate embeddings. The architecture 2000 may be provided by or on a server computer such as the server computer system 120. In particular, the architecture 2000 may be provided by or on a server computer that maintains a RAG model such as the RAG model 300 as described herein with reference to FIG. 3. In at least some implementations, the architecture 2000 may be provided on multiple computer systems. These multiple computer systems may operate in a cooperative manner. In at least some implementations, one or more of the models or modules that are illustrated as being provided in the architecture 2000 may be, instead, be provided on another system, including a third-party system.

The architecture 2000 includes an LLM query encoder 2030 and an LLM document encoder 2040. The LLM query encoder 2030 is an LLM that has been modified to act as a text encoder. Likewise, the LLM document encoder 2040 is an LLM that has been modified to act as a text encoder. In some embodiments, the LLM query encoder 2030 and the LLM document encoder 2040 may be the same document encoder. FIG. 20 shows the LLM query encoder 2030 receiving the query 2010 to generate query embeddings or query embedding vectors 2032. Likewise, FIG. 20 shows the LLM document encoder 2040 receiving the document 2020 to generate the document embeddings or document embedding vectors 2042. The query 2010 may be similar to the query 310, the synthetic queries 1150, the query 1510, the query 1710, or the query 1715, as described herein with reference to FIGS. 3, 11, 15, 17A and 17B. The document 2020 may be similar to the documents 334, the base document 1110, the documents 1520, the document 1720, or the document 1725 as described herein with reference to FIGS. 3, 11, 15, 17A, and 17B.

The query embeddings 2032 and the document embeddings 2042 may be in a shared embedding space.

FIG. 20 further shows the MaxSim mechanism of ColBERT being used to compute a relevance score 2060. Specifically, for each query embedding of the query embedding 2032, its maximum similarity (or MaxSim) among the document embeddings 2042 is determined. That is, for example, for the first one of the query embeddings 2032 (the leftmost query embedding), a MaxSim 2050 is computed. The MaxSim 2050 is computed by calculating the first query embedding's inner product with each of the document embeddings 2042. Amongst these inner products, the maximum inner product is selected as the MaxSim 2050. MaxSims 2052, 2054, and 2056 may be computed similarly for their respective query embedding.

Once the MaxSims 2050-2056 are obtained, the relevance score 2060 may be computed based on the MaxSims 2050-2056. In some embodiments, the relevance score 2060 may be computed as a sum of the MaxSims 2050-2056.

It should be appreciated that while FIG. 20 shows 4 query embeddings 2032 and 5 document embedding 2042, the number of query embeddings 2032 or the document embeddings 2042 may not necessarily be 4 or 5.

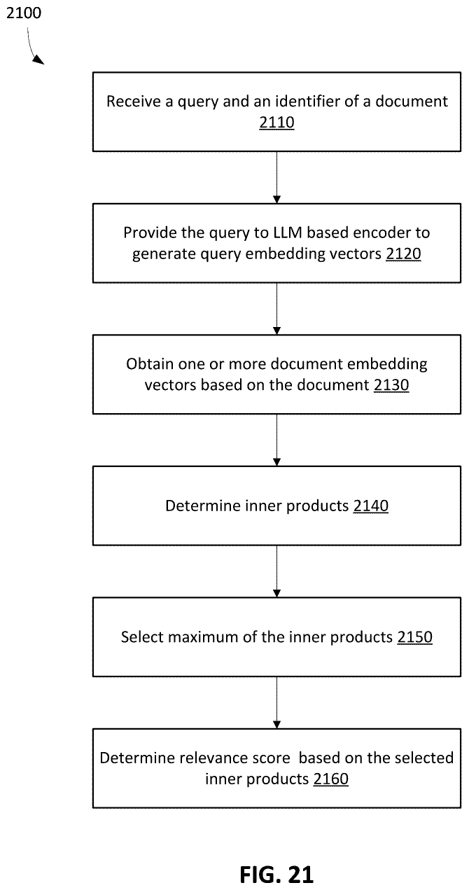

Reference is now made to FIG. 21 which shows, in flowchart form, a method 2100 for determining a relevance score based on a query and a document. The method 2100 may, in least some implementations, be performed by one or both of a processor and a computer. For example, a memory may store instructions which, when executed, configure one or both of the processor and the computer to perform the method 2100 or a portion thereof. The method 2100 may be executed by, for example, a computer system that provides a reranking model with an architecture such as the architecture 2000 as described herein with reference to FIG. 20.

The method 2100 may begin with an operation 2110. The operation 2110 may include receiving a query and an identifier of a document. The query may be similar to the query 2010 as described herein with reference to FIG. 20. The document may be similar to the document 2020 as described herein with reference to FIG. 20. The identifier of the document may be data that can identify the document. The identifier may be used to, for example, retrieve the document, or embeddings of the document, from a cache or other storage medium.

Following the operation 2110, the method 2100 may proceed to an operation 2120. The operation 2120 may include providing the query to an LLM based encoder to generate one or more query embedding vectors. The one or more query embedding vectors may be similar to the query embeddings 2032 as described herein with reference to FIG. 20. The LLM based encoder may be similar to the LLM query encoder 2030 as described herein with reference to FIG. 20.

Following the operation 2120, the method 2100 may proceed to an operation 2130. The operation 2130 may include obtaining one or more document embedding vectors based on the document. The one or more document embedding vectors may be similar to the document embeddings 2042 as described herein with reference to FIG. 20. The document embedding vectors may be generated by an LLM encoder similar to the LLM document encoder 2040 as described herein with reference to FIG. 20. In some embodiments, the document embedding vectors may be precomputed. For example, prior to receiving the query, the processor may have received the document and generated the document embedding vectors by providing the document to an LLM based document encoder. In this example, the processor may store the generated document embedding vectors in a storage medium such as a cache. The document embedding vectors may be stored in the storage medium in association with the identifier of the document. In this example, in response to receiving the query and the identifier of the document, the processor may obtain the document embedding vectors by retrieving the document embedding vectors from the storage medium. The retrieval may involve a lookup operation in the storage medium based on the identifier of the document.

Following the operation 2130, the method 2100 may proceed to an operation 2140. The operation 2140 may include determining inner products between the query embedding vectors and the document embedding vectors. Specifically, for each of the one or more query embedding vectors, the processor may determine an inner product for each document embedding vector with that query embedding vector. That is, the processor may determine for each pair of a query embedding vector and a document embedding vector, an inner product based on that pair. The inner product may be considered a measure of similarity between the pair.

Following the operation 2140, the method 2100 may proceed to an operation 2150. The operation 2150 may include selecting, for each query embedding vector, its maximum inner product. This maximum inner product may be similar to the MaxSims 2050-2056 as described herein with reference to FIG. 20. Additionally or alternatively, it may be said that for each of the query embedding vectors, the processor selects an inner product based on one or more criteria. This one or more criteria may include that the selected inner product is the maximum inner product of that query embedding vector.

Following the operation 2150, the method 2100 may proceed to an operation 2160. The operation 2160 may include determining a relevance score based on the inner products selected in the operation 2150. In some embodiments, the relevance score may be determined by summing the selected inner products.

The relevance score computed in the operation 2160 may be used to determine the relevance of the document relative to other documents in a reranking operation. Further, it should be appreciated that the method 2100 may be executed in the context of running or using a reranking model of a RAG model. Accordingly, upon determining that the document is relevant to the query, the processor may provide the query and the document to an LLM of the RAG model to generate an output. Additionally or alternatively, the processor may provide data based on the document to the LLM to generate the output. Data based on the document may be, without limitation, the document, the document embedding vectors, or the identifier of the document.

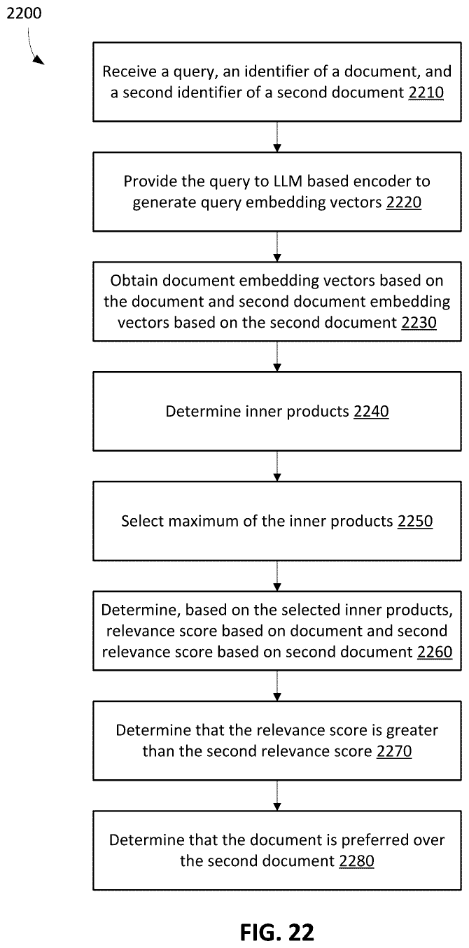

Reference is now made to FIG. 22 which shows, in flowchart form, a method 2200 for comparing the relevance of two documents relative to a query. The method 2200 may, in least some implementations, be performed by one or both of a processor and a computer. For example, a memory may store instructions which, when executed, configure one or both of the processor and the computer to perform the method 2200 or a portion thereof. The method 2200 may be executed by, for example, a computer system that provides a reranking model with an architecture such as the architecture 2000 as described herein with reference to FIG. 20.

The method 2200 may begin with an operation 2210. The operation 2210 may include receiving a query, an identifier of a document, and a second identifier of a second document. The operation 2210 may be similar to the operation 2110 as described herein with reference to FIG. 21. That is, the query of the operation 2210 may be similar to the query of the operation 2110. Likewise, the identifier of the document and the second identifier of the second document of the operation 2210 may be similar to the identifier of the document of the operation 2110. The document and the second document may both be part of the same document corpus.

Following the operation 2210, the method 2200 may proceed to an operation 2220. The operation 2220 may include providing the query to an LLM based encoder to generate query embedding vectors. The operation 2220 may be similar to the operation 2120 as described herein with reference to FIG. 21.

Following the operation 2220, the method 2200 may proceed to an operation 2230. The operation 2230 may include obtaining document embedding vectors based on the document and second document embedding vectors based on the second document. The performance of the operation 2230 may be similar to the performance of the operation 2130 of the method 2100 as described herein with reference to FIG. 21. In particular, the operation 2230 may be considered to include a repeating of the operation 2130 for the second document.

Following the operation 2230, the method 2200 may proceed to an operation 2240. The operation 2240 may include determining the inner products between the query embedding vectors and the document embedding vectors. The operation 2240 may further include determining the inner products between the query embedding vectors and the second document embedding vectors. The operation 2240 may be performed similarly to the operation 2140 of the method 2100 as described herein with reference to FIG. 21. In particular, the operation 2240 may be considered a repeated performance of the operation 2140; one performance for the document and another performance for the second document. In the repeated performance for the second document, it may be said that the operation 2240 includes the determining of second inner products between the query embedding vectors and the second document embedding vectors.

Following the operation 2240, the method 2200 may proceed to an operation 2250. The operation 2250 may include selecting, for each query embedding vector, its maximum inner product with the document embedding vectors and its maximum inner product with the second document embedding vectors. The operation 2250 may be similar to the operation 2150 of the method 2100 as described herein with reference to FIG. 21. In particular, the operation 2250 may be considered a repeated performance of the operation 2150; one performance for the document and another performance for the second document. In the repeated performance for the second document, it may be said that the operation 2250 includes the selecting of the second inner products.

Following the operation 2250, the method 2200 may proceed to an operation 2260. The operation 2260 may include determining, based on the selected inner products, a relevance score based on the document and a second relevance score based on the second document. Put another way, the operation 2260 may include 1) determining the relevance score based on the selected inner products from amongst the inner products of the query embedding vectors and the document embeddings vectors, and 2) determining the second relevance score based on the selected second inner products from amongst the second inner products of the query embedding vectors and the second document embedding vectors. The operation 2260 may be similar to the operation 2160 of the method 2100 as described herein with reference to FIG. 21. In particular, the operation 2260 may be considered to be a repeated performance of the operation 2160; one performance for the document and another performance of the second document.

Following the operation 2260, the method 2200 may proceed to an operation 2270. The operation 2270 may include determining that the relevance score is greater than the second relevance score.

Following the operation 2270, the method 2200 may proceed to an operation 2280. The operation 2280 may include determining, in response to determining that the relevance score is greater than the second relevance score, that the document is preferred relative to the second document. That is, the processor may determine that the document is more relevant to the query than the second document. As a consequence of determining that the document is more relevant to the query than the second document, in the context of running and/or using a reranking model of a RAG model, the processor may provide the document, and not the second document, to an LLM to generate an output.

It should be appreciated that the operations 2270 and 2280 may be generalized to include other criteria for determining preference or greater relevance to the query. For example, the document with the lower relevance score may be the preferred document. In another example, the document with the relevance score closer to or farther from 0 may be the preferred embodiment.

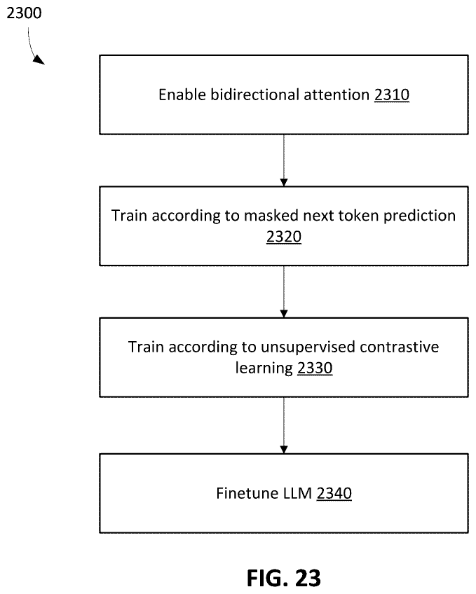

As described herein with reference to FIG. 20, an LLM may be modified to act as an encoder. That is, an LLM may be converted or modified into an LLM based encoder. Reference is now made to FIG. 23 which shows, in flowchart form, a method 2300 for modifying an LLM to become or act as an LLM based encoder. The method 2300 may, in least some implementations, be performed by one or both of a processor and a computer. For example, a memory may store instructions which, when executed, configure one or both of the processor and the computer to perform the method 2300 or a portion thereof. The method 2300 may be executed by, for example, a computer system that provides a reranking model with an architecture such as the architecture 2000 as described herein with reference to FIG. 20.

The method 2300 includes an operation 2310. The operation 2310 includes enabling, within the architecture of an LLM, bidirectional attention. That is, the processor may enable bidirectional attention for at least one attention layer of the LLM. Attnetion layers in LLMs are usually unidirectional. That is, given a sequence of input tokens or embeddings to an attention layer of an LLM, the attention layer employs masking so that the tokens or embeddings cannot attend to tokens or embeddings that are later in the sequence. That is, in a typical attention layer of an LLM, due to masking, the ith input token cannot attend to the jth input token if j is greater than i. Removing this masking may cause all tokens or embedding that are input to an attention layer to be able attend to each other without limitation.

The method 2300 further includes an operation 2320. The operation 2320 includes training the LLM, that has one or more bidirectional attention layers, according to masked next token prediction. In masked next token prediction, given a sequence of tokens or embeddings (x₁, . . . , x_{N}) as input, some of the tokens or embeddings are masked. The LLM is then trained o predict the masked token. When predicting a masked token at position i, the loss is computed based on the logits obtained from the token or embedding representation at the previous position i−1. It may be said that the operation 2320 includes training the LLM may be trained to perform masked next token prediction. The masked next token prediction may include 1) receiving a training query; 2) obtaining a masked representation of the training query based on tokenizing the training query into a sequence of one or more tokens and masking at least one of the one or more tokens; and 3) training the LLM to predict the at least one of the one or more tokens that have been masked. Further, the training may include 1) obtaining a logit in association with a previous token, the previous token being placed in the sequence one place before at least one of the one or more tokens that have been masked; and 2) determining a loss based at least on the logit.

The method 2300 further includes an operation 2330. The operation 2330 includes training the LLM, that has one or more bidirectional attention layers, according to unsupervised contrastive learning. In unsupervised contrastive learning, an input query is passed to the LLM twice. For each pass, the input query is masked in different places. Put another way, the two passes involve independently sampled dropout masks resulting in different representations of the same input query. The LLM is trained to maximize similarity of the two representations of the input query with each other while minimizing the similarity of the representations of the input queries with representations of other queries. That is, training the LLM may include 1) receiving at least a first query and a second query; 2) generating, based on the first query, the second query, and masking, a first representation of the first query and a second representation of the first query, the first and second representations of the first query being different from each other; and 3) training the LLM to maximize similarity between the first and second representations and minimize similarity between at least one of the first and second representations and at least one representation derived based on the second query.

The method 2300 further includes an operation 2340. The operation 2340 includes finetuning the LLM. An LLM that is converted to an LLM based encoder via the operations 2310-2330 may be a dense encoder that encapsulates its input into one dense vector embedding. LLM2Vec is an example of such a dense encoder. To enable the MaxSim mechanism of ColBERT with the LLM, the LLM may be finetuned to output more than one output or embedding.

It should be appreciated that the LLM that is modified according to the method 2300 may be a pre-trained model. Accordingly, the method 2300 enables the obtaining of an LLM based encoder without spending immense computing resources to train the LLM.

While FIG. 20 shows an architecture wherein outputs of LLM encoders are passed to a MaxSim mechanism seen in ColBERT, ColBERT-style LLM based encoders or relevance scorers may be obtained in other ways. An LLM encoder may be finetuned using multiple scoring functions. The LLM encoder may use both dense scoring and ColBERT scoring functions. Dense scoring assigns a single vector representation per query/document and computes a similarity. The similarity may use a dot product or a cosine similarity. ColBERT scoring may use multiple token-wise embeddings and may perform MaxSim pooling for better fine-grained matching.

The dense scoring may be an LLM2Vec-based dense scoring. In LLM2Vec, an LLM with bidirectional attention may encode text into a single dense vector representation. Retrieval may then be performed by comparing these vectors using similarity measures, such as dot product or cosine similarity. This dense scoring method contrasts with techniques like ColBERT, which operate at a token level with late interaction scoring. The finetuning may, therefore, use both ColBERT scoring and dense scoring.

By leveraging the power of LLMs to generate rich, context-aware embeddings, LLM2Vec provides an effective and efficient means of capturing semantic nuances. This dense representation allows for fast similarity computations across large corpora, making LLM2Vec well-suited for retrieval tasks where speed and accuracy are both essential.

Notably, the LLM encoder may be finetuned to balance both scoring methods.

Additionally or alternatively, an LLM may be trained to score relevance in a ColBERT style via distillation. For example, the architecture of an LLM may be modified according operations similar to the operations 2310 to 2330 of the method 2300. Then, in an operation similar to the operation 2340, the knowledge of a ColBERT-style model may be distilled into the LLM with the modified architecture.

It has been found that an LLM encoder may demonstrate impressive results without any pretraining. Normally, ColBERT-style models require pretraining on large-scale retrieval data before fine-tuning. However, by directly finetuning the LLM with both scoring functions, impressive results may be obtained without the need for pretraining. Notably, pre-training of a ColBERT model is a computationally expensive task and is a time-intensive task. Accordingly, by finetuning the LLM encoder in this way, the computationally expensive and time consuming pre-training may be avoided.

Accordingly, a pre-trained LLM may be finetuned to become a ColBERT-style model that can now produce more embeddings for each input. This model may create a similarity score indicating how relevant a document is to a query.

Dense scoring may provide for fast retrieval, compact storage and may work well for broad matching. However, it may lose fine-grained token-level relevance. In contrast, ColBERT-style scoring may capture deep semantic relationships at the toke level and is better for exact matching, but it may be slower and require storing multiple token embeddings per document.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A computer system comprising:
at least one processor;
a memory coupled to the at least one processor, the memory storing instructions that, when executed, configure the at least one processor to:
associate one or more foundation models with a current model designation;
perform an iterative process until a termination condition is satisfied, the iterative process including:
generating, based on the one or more models associated with the current model designation, one or more student models, the one or more student models being machine learning models; and
associating the generated one or more student models with the current model designation; and
deploy the one or more models associated with the current model designation to an artificial intelligence system.

2. The computer system of claim 1 wherein the iterative process further includes:
determining that the termination condition is unsatisfied; and
triggering, in response to determining that the termination condition is unsatisfied, an iteration of the iterative process.

3. The computer system of claim 1 wherein generating the one or more student models includes distilling knowledge of the one or more models associated with the current model designation to the one or more student models.

4. The computer system of claim 1 wherein the one or more foundation models includes a foundation embedding model and a foundation reranking model.

5. The computer system of claim 1 wherein the termination condition includes at least one criterion, one of the at least one criterion being that, after performing at least one iteration of the iterative process, performance of the one or more student models associated with the current model designation is within a threshold relative to a performance of the one or more foundation models.

6. The computer system of claim 5 wherein an iteration of the iterative process further includes, subsequent to associating the generated one or more student models with the current model designation:
providing at least one query to the one or more student models associated with the current model designation;
receiving, in response to providing the at least one query to the one or more student models associated with the current model designation, at least one reply;
determining, based at least on the at least one reply, at least one metric;
determining, based on the at least one metric, that the performance of the one or more student models is within the threshold relative to the performance of the one or more foundation models; and
terminating, in response to determining that the performance of the one or more student models is within the threshold relative to the performance of the one or more foundation models, the iterative process.

7. The computer system of claim 5 wherein an iteration of the iterative process further includes, subsequent to associating the generated one or more student models with the current model designation:
providing at least one query to the one or more student models associated with the current model designation;
receiving, in response to providing the at least one query to the one or more student models associated with the current model designation, at least one reply;
determining, based at least on the at least one reply, at least one metric;
determining, based on the at least one metric, that the performance of the one or more student models is not within the threshold relative to the performance of the one or more foundation models; and
triggering, in response to determining that the performance of the one or more student models is not within the threshold relative to the performance of the one or more foundation models, another iteration of the iterative process.

8. The computer system of claim 1 wherein:
the termination condition includes at least one criterion, one of the at least one criterion being based on an improvement metric; and
the iterative process further includes:
prior to associating the generated one or more student models with the current model designation, associating the models associated with the current model designation with a previous model designation; and
subsequent to associating the generated one or more student models with the current model designation, determining the improvement metric based on providing at least one query to:
the models associated with the previous model designation; and
the models associated with the current model designation.

9. The computer system of claim 8 wherein an iteration of the iterative process further includes:
determining that the improvement metric indicates that an improvement in performance of the models associated with the current model designation relative to performance of the models associated with the previous model designation is within a threshold; and, in response thereto,
terminating the iterative process.

10. The computer system of claim 8 wherein an iteration of the iterative process further includes:
determining that the improvement metric indicates that an improvement in performance of the models associated with the current model designation relative to performance of the models associated with the previous model designation is not within a threshold; and, in response thereto,
triggering another iteration of the iterative process.

11. A computer-implemented method for iteratively performing artificial intelligence distillation, the method comprising:
associating one or more foundation models with a current model designation;
performing an iterative process until a termination condition is satisfied, the iterative process including:
generating, based on the one or more models associated with the current model designation, one or more student models, the one or more student models being machine learning models; and
associating the generated one or more student models with the current model designation; and
deploying the one or more models associated with the current model designation to an artificial intelligence system.

12. The computer-implemented method of claim 11 wherein generating the one or more student models includes distilling knowledge of the one or more models associated with the current model designation to the one or more student models.

13. The computer-implemented method of claim 11 wherein the one or more foundation models includes a foundation embedding model and a foundation reranking model.

14. The computer-implemented method of claim 11 wherein the termination condition includes at least one criterion, one of the at least one criterion being that, after performing at least one iteration of the iterative process, performance of the one or more student models associated with the current model designation is within a threshold relative to performance of the one or more foundation models.

15. The computer-implemented method of claim 14 wherein an iteration of the iterative process further includes, subsequent to associating the generated one or more student models with the current model designation:
providing at least one query to the one or more student models associated with the current model designation;
receiving, in response to providing the at least one query to the one or more student models associated with the current model designation, at least one reply;
determining, based at least on the at least one reply, at least one metric;
determining, based on the at least one metric, that the performance of the one or more student models is within the threshold relative to the performance of the one or more foundation models; and
terminating, in response to determining that the performance of the one or more student models is within the threshold relative to the performance of the one or more foundation models, the iterative process.

16. The computer-implemented method of claim 14 wherein an iteration of the iterative process further includes, subsequent to associating the generated one or more student models with the current model designation:
providing at least one query to the one or more student models associated with the current model designation;
receiving, in response to providing the at least one query to the one or more student models associated with the current model designation, at least one reply;
determining, based at least on the at least one reply, at least one metric;
determining, based on the at least one metric, that the performance of the one or more student models is not within the threshold relative to the performance of the one or more foundation models; and
triggering, in response to determining that the performance of the one or more student models is not within the threshold relative to the performance of the one or more foundation models, another iteration of the iterative process.

17. The computer-implemented method of claim 11 wherein:
the termination condition includes at least one criterion, one of the at least one criterion being based on an improvement metric; and
the iterative process further includes:
prior to associating the generated one or more student models with the current model designation, associating the models associated with the current model designation with a previous model designation; and
subsequent to associating the generated one or more student models with the current model designation, determining the improvement metric based on providing at least one query to:
the models associated with the previous model designation; and
the models associated with the current model designation.

18. The computer-implemented method of claim 17 wherein an iteration of the iterative process further includes:
determining that the improvement metric indicates that an improvement in performance of the models associated with the current model designation relative to performance of the models associated with the previous model designation is within a threshold; and, in response thereto,
terminating the iterative process.

19. The computer-implemented method of claim 17 wherein an iteration of the iterative process further includes:
determining that the improvement metric indicates that an improvement in performance of the models associated with the current model designation relative to performance of the models associated with the previous model designation is not within a threshold; and, in response thereto,
triggering another iteration of the iterative process.

20. A non-transitory computer-readable medium storing computer-readable instructions that, when executed by at least one processor, configure that at least one processor to:
associate one or more foundation models with a current model designation;
perform an iterative process until a termination condition is satisfied, the iterative process including:
generating, based on the one or more models associated with the current model designation, one or more student models, the one or more student models being machine learning models; and
associating the generated one or more student models with the current model designation; and
deploy the one or more models associated with the current model designation to an artificial intelligence system.
